(19) United States
(12) Patent Application Publication
(10) Pub. No.: US 2017/0111569 A1
(43) Pub. Date: Apr. 20, 2017

(54) FACE DETECTION METHOD AND ELECTRONIC DEVICE FOR SUPPORTING THE SAME

(71) Applicant: Samsung Electronics Co. , Ltd., Gyeonggi-do (KR)

(72) Inventor: Jong Sun KIM, Gyeonggi-do (KR)

(73) Assignee: Samsung Electronics Co. , Ltd.

(21) Appl. No.: 15/298,942

(22) Filed: Oct. 20, 2016

(30) Foreign Application Priority Data
Oct. 20, 2015 (KR) 10-2015-0146253

(51) Int. Cl. H04N 5/232; H04N 5/235; G06K 9/00

(52) U.S. Cl. CPC H04N 5/23219; G06K 9/00241; H04N 5/2353; H04N 5/2351

(57) ABSTRACT

Methods and apparatus are provided for obtaining an image for an object. The image of the object is obtained using a first exposure configuration. It is determined whether a designated shape is in the image based on luminance information of the image. The first exposure configuration is changed to a second exposure configuration, when the designated shape is in the image.

### PRIORITY

This application claims priority under 35 U.S.C. §119(a) to Korean Patent Application No. 10-2015-0146253, filed in the Korean Intellectual Property Office on Oct. 20, 2015, the disclosure of which is incorporated herein by reference.

### BACKGROUND

1. Field of the Disclosure

The present disclosure relates generally to face detection methods and electronic devices for supporting the same, and more particularly, to face detection methods with exposure configuration compensation and electronic devices for supporting the same.

2. Description of the Related Art

Electronic devices, such as, for example, digital cameras, digital camcorders, or smartphones, for photographing objects using their image sensors are widely used. Such electronic devices may perform a face detection function of distinguishing a face of a person from a background or an object, in order to more clearly photograph the face of the person. However, a face shape of a person is not clearly shown in a backlight condition, making it is difficult for the conventional electronic device to detect a face in this condition.

### SUMMARY

The present disclosure has been made to address at least the above problems and/or disadvantages and to provide at least the advantages described below. Accordingly, an aspect of the present disclosure provides a face detection method configured to change an exposure configuration if a specified shape is detected in an image, and an electronic device for supporting the same.

In accordance with an aspect of the present disclosure, an electronic device is provided that includes a photographing module configured to obtain an image of an object using a first exposure configuration. The electronic device also includes a processor configured to determine whether a designated shape is in the image based on luminance information of the image, and change the first exposure configuration to a second exposure configuration when the designated shape is in the image.

In accordance with another aspect of the present disclosure, an electronic device is provided for obtaining an image for an object. The electronic device includes a memory configured to store the image, and a display configured to output a preview image for the image. The electronic device also includes a processor configured to store the image in the memory if user input for an image photographing command is received, and to determine whether a designated shape is in the image based on luminance information of the image. The processor is further configured to change an exposure configuration of a photographing module of the electronic device when the designated shape is in the image.

In accordance with another aspect of the present disclosure, a face detection method of an electronic device is provided. An image of an object is obtained using a first exposure configuration. It is determined whether a designated shape is in the image based on luminance information of the image. The first exposure configuration is changed to a second exposure configuration, when the designated shape is in the image.

### BRIEF DESCRIPTION OF THE DRAWINGS

The above and other aspects, features, and advantages of the present disclosure will be more apparent from the following detailed description when taken in conjunction with the accompanying drawings, in which:

FIG. 1 is a block diagram illustrating a configuration of an electronic device associated with face detection, according to an embodiment of the present disclosure;

FIG. 2A is diagram illustrating a side view of a camera that mounts a face detection function, according to an embodiment of the present disclosure;

FIG. 2B is a diagram illustrating a rear view of a camera that mounts a face detection function, according to an embodiment of the present disclosure;

FIG. 3A is a diagram illustrating a side view of a smartphone that mounts a face detection function, according to an embodiment of the present disclosure;

FIG. 3B is a diagram illustrating a rear view of a smartphone that mounts a face detection function, according to an embodiment of the present disclosure;

FIG. 4 is a block diagram illustrating a configuration of a processor associated with face detection, according to an embodiment of the present disclosure;

FIG. 5 is a flowchart illustrating an operation method of an electronic device associated with face detection, according to an embodiment of the present disclosure;

FIG. 6 is a flowchart illustrating an operation method of an electronic device associated with detecting a specified shape from an image, according to an embodiment of the present disclosure;

FIG. 7 is a flowchart illustrating an operation method of an electronic device associated with changing an exposure configuration, according to an embodiment of the present disclosure;

FIG. 8 is a flowchart illustrating an operation method of an electronic device associated with face detection using stored image data, according to an embodiment of the present disclosure;

FIG. 9 is a diagram illustrating detection of a specified shape from an image, according to an embodiment of the present disclosure;

FIG. 10 is a screen illustrating an operation of changing an exposure configuration and detecting a face, according to an embodiment of the present disclosure;

FIG. 11A is a diagram illustrating an exposure configuration based on a distribution state of feature points in a specified shape, according to an embodiment of the present disclosure;

FIG. 11B is a diagram illustrating an exposure configuration based on a distribution state of feature points in a specified shape, according to another embodiment of the present disclosure;

FIG. 12 is a screen illustrating an operation of detecting a face using stored image data, according to an embodiment of the present disclosure;

FIG. 13 is a diagram illustrating a pattern in which a face shape is stored, according to an embodiment of the present disclosure;

FIG. 14 is a diagram illustrating an electronic device in a network environment, according to an embodiment of the present disclosure;

FIG. 15 is a block diagram illustrating an electronic device, according to an embodiment of the present disclosure; and

FIG. 16 is a block diagram illustrating a program module, according to an embodiment of the present disclosure.

### DETAILED DESCRIPTION

Embodiments of the present disclosure are described in detail with reference to the accompanying drawings. The same or similar components may be designated by the same or similar reference numerals although they are illustrated in different drawings. Detailed descriptions of constructions or processes known in the art may be omitted to avoid obscuring the subject matter of the present disclosure.

The terms and words used herein are not limited to their dictionary meanings, but, are merely used to enable a clear and consistent understanding of the present disclosure. Accordingly, it should be apparent to those skilled in the art that the following description of various embodiments of the present disclosure is provided for illustrative purposes only and not for the purpose of limiting the present disclosure.

It is to be understood that the singular forms “a,” “an,” and “the” include plural referents unless the context clearly dictates otherwise. Thus, for example, reference to “a component surface” includes reference to one or more of such surfaces.

The terms “include,” “comprise,” “have,” “may include,” “may comprise,” and “may have”, as used herein, indicate disclosed functions, operations, or the existence of elements, but do not exclude other functions, operations or elements.

For example, the expressions “A or B,” and “at least one of A and B” may indicate A and B, A, or B. For instance, the expressions “A or B” and “at least one of A and B” may indicate at least one A, at least one B, or both at least one A and at least one B.

The terms such as “1st,” “2nd,” “first,” “second,” and the like, as used herein, may refer to modifying various different elements of various embodiments of the present disclosure, but are not intended to limit the elements. For example, “a first user device” and “a second user device” may indicate different users regardless of order or importance. A first component may be referred to as a second component and vice versa without departing from the scope and spirit of the present disclosure.

In various embodiments of the present disclosure, it is intended that when a component (for example, a first component) is referred to as being “operatively or communicatively coupled with/to” or “connected to” another component (for example, a second component), the component may be directly connected to the other component or connected through another component (for example, a third component). In various embodiments of the present disclosure, it is intended that when a component (for example, a first component) is referred to as being “directly connected to” or “directly accessed by” another component (for example, a second component), another component (for example, a third component) does not exist between the component (for example, the first component) and the other component (for example, the second component).

The expression “configured to”, as used herein, may be interchangeably used with “suitable for,” “having the capacity to,” “designed to,” “adapted to,” “made to,” and “capable of”, according to the situation. The term “configured to” may not necessarily indicate “specifically designed to” in terms of hardware. Instead, the expression “a device configured to” in some situations may indicate that the device and another device or part are “capable of.” For example, the expression “a processor configured to perform A, B, and C” may indicate a dedicated processor (for example, an embedded processor) for performing a corresponding operation or a general purpose processor (for example, a central processing unit (CPU) or application processor (AP)) for performing corresponding operations by executing at least one software program stored in a memory device.

Terms used in various embodiments of the present disclosure are used to describe certain embodiments of the present disclosure, but are not intended to limit the scope of other embodiments. The terms used herein may have the same meanings that are generally understood by a person skilled in the art. In general, a term defined in a dictionary should be considered to have the same meaning as the contextual meaning of the related art, and, unless clearly defined herein, should not be understood differently or as having an excessively formal meaning. In any case, even the terms defined in the present specification are not intended to be interpreted as excluding embodiments of the present disclosure.

An electronic device according to various embodiments of the present disclosure may be embodied as at least one of a smartphone, a tablet personal computer (PC), a mobile phone, a video telephone, an electronic book reader, a desktop PC, a laptop PC, a netbook computer, a workstation, a server, a personal digital assistant (PDA), a portable multimedia player (PMP), a Motion Picture Experts Group (MPEG-1 or MPEG-2) Audio Layer 3 (MP3) player, a mobile medical device, a camera, or a wearable device. The wearable device may include at least one of an accessory-type device (e.g., a watch, a ring, a bracelet, an anklet, a necklace, glasses, a contact lens, a head-mounted device (HMD)), a textile- or clothing-integrated-type device (e.g., an electronic apparel), a body-attached-type device (e.g., a skin pad or a tattoo), or a bio-implantable-type device (e.g., an implantable circuit)

In some embodiments of the present disclosure, an electronic device may be embodied as a home appliance. The smart home appliance may include at least one of, for example, a television (TV), a digital video/versatile disc (DVD) player, an audio, a refrigerator, an air conditioner, a cleaner, an oven, a microwave oven, a washing machine, an air cleaner, a set-top box, a home automation control panel, a security control panel, a TV box, a game console, an electronic dictionary, an electronic key, a camcorder, or an electronic picture frame

In other embodiments of the present disclosure, an electronic device may be embodied as at least one of various medical devices (e.g., various portable medical measurement devices (e.g., a blood glucose measuring device, a heart rate measuring device, a blood pressure measuring device, a body temperature measuring device, or the like), a magnetic resonance angiography (MRA), a magnetic resonance imaging (MRI), a computed tomography (CT), a scanner, an ultrasonic device, or the like), a navigation device, a global navigation satellite system (GNSS), an event data recorder (EDR), a flight data recorder (FDR), a vehicle infotainment device, electronic equipment for vessels (e.g., a navigation system, a gyrocompass, or the like), avionics, a security device, a head unit for a vehicle, an industrial or home robot, an automated teller machine (ATM), a point of sales (POS) device of a store, or an Internet of things (IoT) device (e.g., a light bulb, various sensors, an electric or gas meter, a sprinkler, a fire alarm, a thermostat, a streetlamp, a toaster, exercise equipment, a hot water tank, a heater, a boiler, or the like).

According to various embodiments of the present disclosure, an electronic device may be embodied as at least one of a part of furniture or a building/structure, an electronic board, an electronic signature receiving device, a projector, or a measuring instrument (e.g., a water meter, an electricity meter, a gas meter, a wave meter, or the like). An electronic device may be one or more combinations of the above-mentioned devices. An electronic device, according to some embodiments of the present disclosure, may be a flexible device. An electronic device, according to an embodiment of the present disclosure, is not limited to the above-described devices, and may include new electronic devices with the development of new technology.

Hereinafter, an electronic device, according to various embodiments of the present disclosure, will be described in more detail with reference to the accompanying drawings. The term “user”, as used herein, may refer to a person who uses an electronic device or may refer to a device (e.g., an artificial intelligence electronic device) that uses an electronic device.

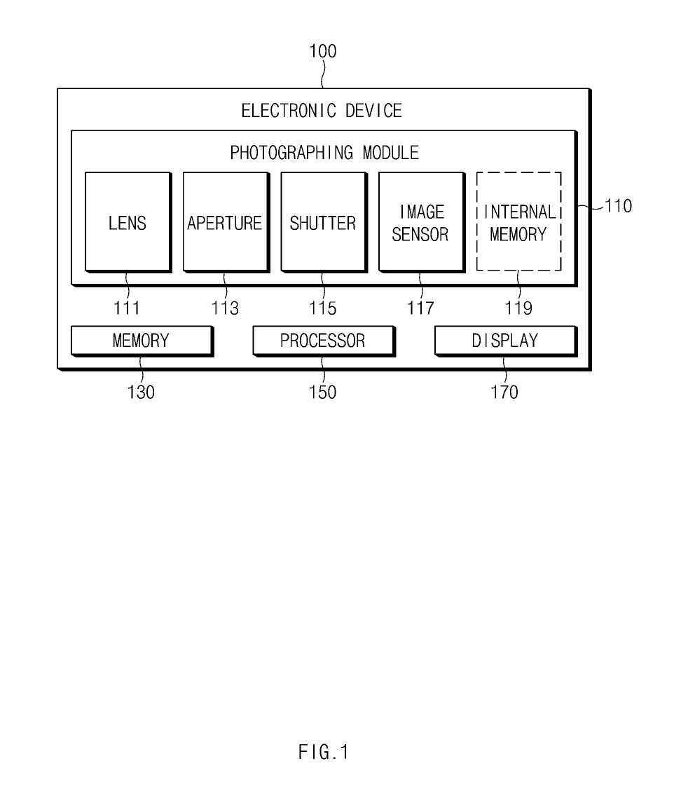

FIG. 1 is a block diagram illustrating a configuration of an electronic device associated with face detection, according to an embodiment of the present disclosure. An electronic device 100 may be a photographing device, which may capture or photograph an object. For example, the electronic device 100 may be a portable electronic device, such as a digital camera, a digital camcorder, or a smartphone, and the like. The electronic device 100 may obtain a still image or a video by photographing. According to various embodiments, the electronic device 100 may provide functions such as, for example, an auto-focus function, an auto-exposure function, and a custom white balance function. However, the functions of the electronic device 100 are not limited thereto. For example, the electronic device 100 may provide a variety of functions, such as a zoom-in function, a zoom-out function, a photographing function, a continuous photographing function, a timer photographing function, a flash on/off function, or a filter function, associated with photographing an image. Therefore, a user of the electronic device 100 may obtain a photographed (or captured) image by setting an image photographing condition using functions provided from the electronic device 100.

According to various embodiments, the electronic device 100 may provide an image, such as a preview image or a live-view image, for showing an image to be photographed in advance through a screen (e.g., a display 170) while a photographing function is performed. For example, if an image photographing condition is set, the electronic device 100 may provide a preview or live-view image to which the image photographing condition is applied.

Referring to FIG. 1, the electronic device 100 includes a photographing module 110, a memory 130, a processor 150, and the display 170. The photographing module 110 includes, for example, a lens 111 for receiving image light of an object and imaging the received image light as an image, an aperture 113 for adjusting an amount of light passing through the lens 111, a shutter 115 for performing a function of opening and closing the aperture 113 such that an image sensor 117 is exposed for a time by light passing through the lens 111, the image sensor 117 for receiving the image imaged by the lens 111 as an optical signal, and an internal memory 119.

The lens 111 may include, for example, a plurality of optical lenses. The lens 111 may receive light input after being reflected from an object such that an image is focused on a photosensitive surface of the image sensor 117. According to an embodiment, the lens 111 may perform a zoom function based on a signal of the processor 150 and may automatically adjust a focus.

According to various embodiments, the lens 111 may be detachably mounted on the electronic device 100. For example, if the lens 111 is mounted on the electronic device 100, it may support a photographing function. If the electronic device 100 does not perform the photographing function, the lens 111 may be detached from the electronic device 100 and may be kept separate. The lens 111 may have various forms. The user may selectively mount the lens 111 on the electronic device 100 based on a photographing mode or a photographing purpose. In various embodiments, the electronic device 100 may further include a lens cover configured to cover the lens 111. For example, the lens cover may allow one surface (e.g., a front surface) of the lens 111 to be opened and closed. Although the lens 111 is mounted on the electronic device 100, the lens cover may block light and maintain a state where the electronic device 100 may not photograph an image. According to various embodiments, the electronic device 100 may further include a separate sensor (e.g., an illumination sensor and the like) and may determine whether the lens cover is combined or whether the lens cover is opened or closed, through the separate sensor. Information indicating whether the lens cover is combined or whether the lens cover is opened or closed may be provided to the processor 150. Therefore, the processor 150 may determine a photographing enable state.

The aperture 113 may adjust an amount of light passing through the lens 111. According to various embodiments, the aperture 113 may be provided in the form of a disc and may be provided such that its region is opened and closed based on an aperture value. Since a path through which light enters varies in size based on a degree in which the region is opened and closed, the aperture 113 may adjust a degree, in which light passing through the lens 111 is exposed to the image sensor 117, in a different way. For example, when an aperture value is higher, a degree in which the region is closed may be more increased. Therefore, an amount of entering light may be more reduced. When an aperture value is lower, a degree in which the region is opened may be more increased and an amount of entering light may be more increased.

The shutter 115 may perform a function of opening and closing the aperture 113. For example, the electronic device 100 may expose light to the image sensor 117 by opening and closing the shutter 115. According to various embodiments, the shutter 115 may adjust an amount of light that enters the image sensor 117 through the lens 111 by adjusting a time of being opened and closed between the lens 111 and the image sensor 117 to be longer or shorter. For example, a degree in which light passing through the lens 111 is exposed to the image sensor 117 may be adjusted in a different way based on a shutter speed at which the shutter 115 is opened and closed.

The image sensor 117 is disposed in a location where image light passing through the lens 111 is provided as an image, and may perform a function of converting the image into an electric signal. The image sensor 117 may include, for example, a charge-coupled device (CCD) image sensor or a complementary metal oxide semiconductor (CMOS) image sensor. According to various embodiments, the image sensor 117 may adjust an amount of absorbed light in a different way based on sensitivity of the image sensor 117. For example, when the sensitivity of the image sensor 117 is higher, an amount of absorbed light may be increased. When the sensitivity of the image sensor 117 is lower, an amount of absorbed light may be reduced.

The internal memory 119 may temporarily store an image photographed (or captured) through the photographing module 110. According to an embodiment, the internal memory 119 may store an image photographed through the image sensor 117 before the shutter 115 is operated. According to various embodiments, the electronic device 100 may provide the image stored in the internal memory 119 as a preview image or a live-view image. In various embodiments, the electronic device 100 may store an image photographed after the shutter 115 is operated in the internal memory 119 and may send the image to the memory 130 corresponding to a selection input by the user or information set by the user. For example, the electronic device 100 may store a first image photographed by a first exposure configuration in the internal memory 119 and may determine to store the first image in the memory 130 corresponding to the selection input. Alternatively, if it is determined that the first image stored in the internal memory 119 is photographed in a backlight condition and a specified shape (e.g., an omega shape) is included in the first image, the electronic device 100 may change the first exposure configuration to a second exposure configuration to reattempt to photograph an image and may directly store a photographed second image in the memory 130 rather than the internal memory 119. In this case, the electronic device 100 may delete the first image from the internal memory 119.

The memory 130 may include a volatile memory and/or a nonvolatile memory. The memory 130 may store instructions or data related to at least one of the other elements of the electronic device 100. According to an embodiment, the memory 130 may store functions associated with face detection as instructions implemented in the form of a program. Therefore, if the instructions are executed by the processor 150, the processor 150 may perform the function associated with the face detection. Also, the memory 130 may store an image photographed through the photographing module 110 and may output the stored image on the display 170 based on a specific instruction executed by the processor 150. According to various embodiments, the memory 130 may include an embedded memory or an external memory.

The processor 150 may include at least one of a CPU, an AP, or a communication processor (CP). The processor 150 may perform data processing or an operation related to communication and/or control of at least one of the other elements of the electronic device 100.

According to various embodiments, the processor 150 may electrically connect with the lens 111, the aperture 113, the shutter 115, or the image sensor 117, and may control a photographing function. The processor 150 may control functions, for example, an auto-focus function, an auto exposure function, a custom white balance function, a zoom-in function, a zoom-out function, a photographing function, a continuous photographing function, a timer photographing function, a flash on/off function, or a filter function, and the like.

According to various embodiments, the processor 150 may electrically connect with the internal memory 119, the memory 130, and the display 170, and may control a function of storing, sending, or outputting a photographed image. For example, the processor 150 may store the photographed image in the internal memory 119 or the memory 130, and may output the image on the display 170.

According to various embodiments, the processor 150 may control an exposure configuration of the photographing module 110. The processor 150 may change at least one of an aperture value, a shutter speed, or sensitivity of an image sensor 117. For example, the processor 150 may control the photographing module 110 to change the first exposure configuration to the second exposure configuration and to photograph an image. The processor 150 may determine whether the first image photographed using the first exposure configuration is an image photographed in a backlight condition. If it is determined that the first image is photographed in the backlight condition, the processor 150 may determine whether a specified shape is present in the first image. Also, if the specified shape is present in the first image, the processor 150 may change the first exposure configuration to the second exposure configuration. The specified shape may be, for example, an omega shape. The processor 150 may determine whether a face of a person is present, based on whether the specified shape is present. A function of the processor 150 associated with face detection is described in greater detail below.

The display 170 may include, for example, a liquid crystal display (LCD), a light-emitting diode (LED) display, an organic light-emitting diode (OLED) display, a microelectromechanical systems (MEMS) display, or an electronic paper display. The display 170 may present various pieces of content (e.g., text, an image, a video, an icon, a symbol, or the like) to the user. According to an embodiment, the display 170 may output an image photographed through the photographing module 110. Also, the display 170 may output an image stored in the internal memory 119 or the memory 130. According to various embodiments, the display 170 may include a touch screen, and may receive a touch, gesture, proximity, or hovering input from an electronic pen or a part of a body of the user.

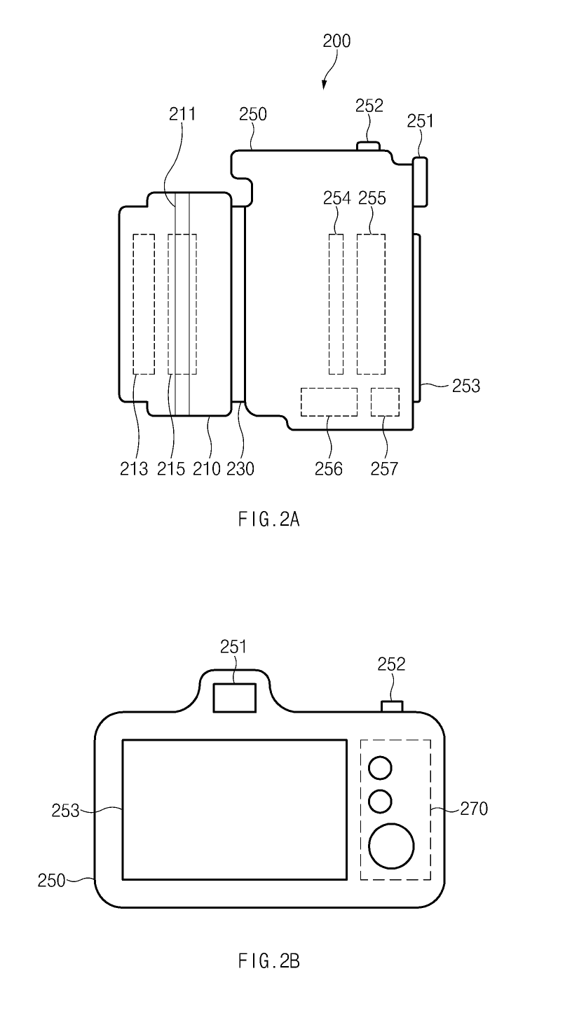

FIG. 2A is a diagram illustrating a side view of a camera that mounts a face detection function, according to an embodiment of the present disclosure. FIG. 2B is a diagram illustrating a rear view of a camera that mounts a face detection function, according to an embodiment of the present disclosure. An electronic device 200 may perform the same functions as or similar functions to the electronic device 100 of FIG. 1. The electronic device 200 may be embodied as a digital camera or a digital camcorder.

Referring to FIGS. 2A and 2B, the electronic device 200 includes a camera lens barrel 210, a lens barrel connecting part 230, and a camera body 250. The camera lens barrel 210 may be attached or detached to the camera body 250 through the lens barrel connecting part 230. For example, the camera lens barrel 210 may be provided in a form where at least one cylindrical portions is connected. In FIGS. 2A and 2B, an embodiment of the present disclosure is exemplified as cylindrical portions having two different diameters connected as one. However, the form of the camera lens barrel 210 is not limited thereto.

According to various embodiments, the camera lens barrel 210 includes an aperture value changing unit 211 that may adjust an aperture value in a physical form in a region of its appearance. The aperture value changing unit 211 may be a band-shaped adjustment device formed along the camera lens barrel 210. For example, a user of the electronic device 200 may rotate the aperture value changing unit 211 along the circumference of the camera lens barrel 210. An opening and a closing degree of the aperture 215 may be adjusted while the aperture value changing unit 211 is rotated. The aperture value changing unit 211 may be formed on an inner side of the electronic device 200 rather than being formed on the circumference of the electronic device 200. Also, the aperture value changing unit 211 may operate via software rather than operating physically (or via hardware). For example, the electronic device 200 may change the aperture value changing unit 211 by a processor 256 based on a program routine.

According to various embodiments, the camera lens barrel 210 includes a lens 213 and an aperture 215 on its inner side. The lens 213 and the aperture 215 may perform the same or similar function to the lens III and the aperture 113 of FIG. 1. The lens 213 may be disposed in a front surface of the camera lens barrel 210 and may pass light which enters from the outside. The camera lens barrel 210 may further include a lens cover at its front surface. The lens cover may perform a function of protecting the lens 213 from external foreign substances. Also, it may be determined whether light enters the lens 213 based on whether the lens cover is opened or closed.

According to various embodiments, the camera lens barrel 210 may be excluded from the electronic device 200. In this case, the aperture value changing unit 211, the lens 213, and the aperture 215 may be included in the camera body 250 of the electronic device 200. Alternatively, the camera lens barrel 210 may be detachably mounted on the camera body 250 by including the aperture value changing unit 211, the lens 213, and the aperture 215 in the camera body 250 and including an additional lens in the camera lens barrel 210.

The lens barrel connecting unit 230 may be formed in a front region of the camera body 250 such that the camera lens barrel 210 is detachably mounted on the camera body 250. Since threads or threaded rods are formed on an outer peripheral surface or an inner peripheral surface of the lens barrel connecting unit 230, the threads or threaded rods of the lens barrel connecting unit 230 may be combined with threaded rods or threads formed on an inner peripheral surface or an outer peripheral surface of the camera lens barrel 210. The form of the lens barrel connecting unit 230 is not limited thereto. For example, the lens barrel connecting unit 230 may include various forms in which it may be combined to the camera body 250. If the aperture value changing unit 211, the lens 213, and the aperture 215 are included in the camera body 250, the electronic device 200 may not include the lens barrel connecting unit 230.

The camera body 250 includes a viewfinder 251, a shutter operating unit 252, a display 253, and a function button 270. The viewfinder 251 may include an optical device which may view an object when photographing the object. For example, the user focuses the camera on the object or may check whether the object is accurately put on a screen, through the viewfinder 251. According to various embodiments, the viewfinder 251 may be of an electronic type rather than an optical type. For example, the viewfinder 251 may provide a preview image photographed through an image sensor 255. The electronic device 200 may not include the viewfinder 251 and may provide a preview image through the display 253.

The shutter operating unit 252 may perform an opening and closing operation of a shutter 254. For example, if the user pushes the shutter operating unit 252, the shutter 254 may be opened and closed for a specified time. According to an embodiment, the shutter operating unit 252 may be provided with a physical button. The shutter operating unit 252 may be provided with a button object displayed on the display 253.

The display 253 may be disposed on a region (e.g., a rear surface) of the camera body 250 and may output an image photographed through the image sensor 255. The display 253 may perform the same function as or a similar function to a display 170 shown in FIG. 1.

The shutter 254, the image sensor 255, the processor 256, and a memory 257 are included in an interior of the camera body 250. The shutter 254, the image sensor 255, the processor 256, and the memory 257 may perform the same functions as or similar functions to the shutter 115, the image sensor 117, the processor 150, and the memory 130 of FIG. 1. Also, the memory 257 may perform a function of an internal memory 119 shown in FIG. 1.

The function button 270 may execute a function implemented in the electronic device 200. The function button 270 may, for example, a power button, a focus adjustment button, an exposure adjustment button, a zoom button, a timer setting button, a flash setting button, or a photographed image display button, corresponding to various functions. According to various embodiments, the electronic device 200 may provide the function button 270 as a physical button. In various embodiments, the function button 270 may be provided with a button object displayed on the display 253. In this case, the electronic device 200 may expand a region of the display 253 to a region disposed when the function button 270 is provided with the physical button to provide a larger screen.

The components of the electronic device 200 shown in FIGS. 2A and 2B are exemplified as describing components of the imaging device. Embodiments of the prevent disclosure are not limited thereto. The electronic device 200 may further include at least one other component other than the above-described components. At least one of the above-described components may be excluded from the electronic device 200. For example, the electronic device 200 may further include a flash module for emitting light when an object is photographed and additionally obtaining an amount of light.

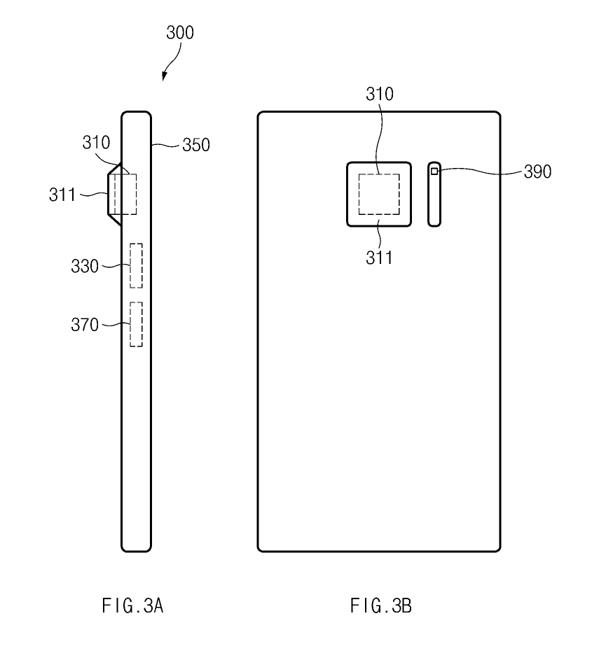

FIG. 3A is a diagram illustrating a side view of a smartphone that mounts a face detection function, according to an embodiment of the present disclosure. FIG. 3B is a diagram illustrating a rear view of a smartphone that mounts a face detection function, according to an embodiment of the present disclosure. An electronic device 300 may perform the same functions as or similar functions to the electronic device 100 of FIG. 1. The electronic device 300 shown in FIGS. 3A and 3B may be a portable electronic device, such as a smartphone.

Referring to FIGS. 3A and 3B, the electronic device 300 includes a photographing module 310, a processor 330, a display 350, and a memory 370. The photographing module 310 may perform the same functions as or similar functions to the photographing module 110 of FIG. 1. Herein, since the electronic device 300 is miniaturized to be provided with a portable device, the photographing module 310 may be miniaturized to be smaller than a photographing module of the electronic device 200 shown in FIGS. 2A and 2B.

According to various embodiments, the electronic device 300 further includes a camera frame 311. The camera frame 311 may be formed on an exterior of the photographing module 310, and may be made of transparent materials such as glass or transparent plastic such that light enters the photographing module 310. The camera frame 311 may protrude from an outer side of the electronic device 300. However, the form of the camera frame is not limited thereto.

According to various embodiments, the electronic device 300 includes a flash module 390. The flash module 390 may emit light when an object is photographed and may obtain an additional amount of light. The flash module 390 may be disposed adjacent to the photographing module 310. In FIGS. 3A and 3B, the flash module 390 is disposed adjacent to an exterior of the camera frame 311. However, the flash module 390 is not limited thereto. In various embodiments, the flash module 390 is disposed in an interior of the camera frame 311.

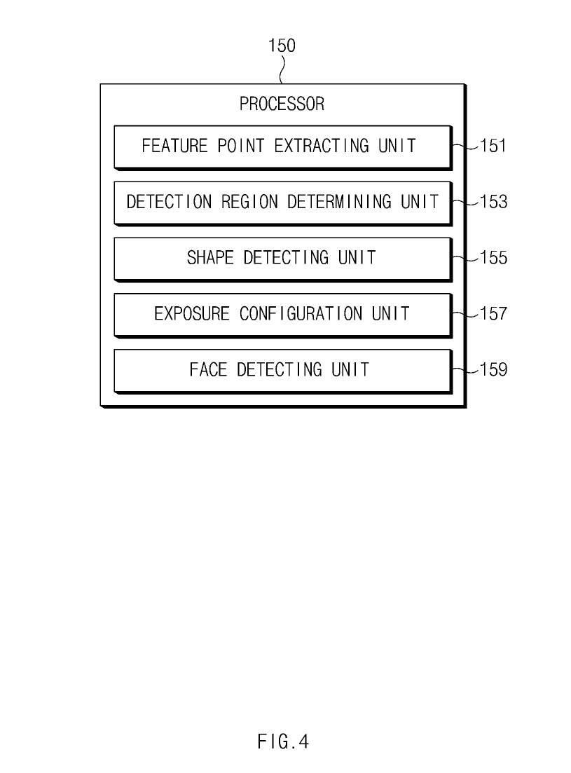

FIG. 4 is a block diagram illustrating a configuration of a processor associated with face detection, according to an embodiment of the present disclosure. In FIG. 4, a function associated with face detection, among the above-described functions of the processor 150 of FIG. 1, is described below in detail.

Referring to FIG. 4, the processor 150 includes a feature point extracting unit 151, a detection region determining unit 153, a shape detecting unit 155, an exposure configuration unit 157, and a face detecting unit 159. The feature point extracting unit 151 may extract a feature point from an image photographed through the image sensor 117 of FIG. 1. The feature point may include a point indicating a feature of the image to detect, track, or recognize an object from an image. For example, the feature point may include a point that may be easily distinguished although each object varies in form, size, or location on the image. Also, the feature point may include a point that may be easily distinguished on the image although a view point or lighting of an imaging device is changed.

According to an embodiment, the feature point extracting unit 151 may extract a corner point or a boundary point of each object as the feature point from the image. The feature point extracting unit 151 may extract feature points through various feature point extracting methods, such as, for example, a scale invariant feature transform (SIFT), a speeded up robust features (SURF), a local binary pattern (LBP), and a modified census transform (MCT). The feature point extracting unit 151 may extract a feature point based on luminance information of the image. For example, if a variation level of a luminance value is greater than a specified level, the feature point extracting unit 151 may extract a corresponding point as a feature point.

If feature points are extracted from the image, the detection region determining unit 153 may set a region, where there are the feature points, to a detection region. According to an embodiment, the detection region determining unit 153 may set a detection region based on a distribution state of the feature points on the image. For example, if the feature points are present within a specified separation distance, the detection region determining unit 153 may include the feature points in one detection region. Feature points that depart from the separation distance may be set to different detection regions. Also, if the feature points included in the one detection region are less than the specified number of the feature points, the detection region determining unit 153 may cancel the setting of the corresponding detection region.

The shape detecting unit 155 may determine whether a specified shape is present in the set detection region. According to an embodiment, the shape detecting unit 155 may detect whether an omega shape corresponding to a face shape of a person is present in the detection region. For example, the shape detecting unit 155 may determine whether feature points included in the detection region are distributed as an omega shape.

According to various embodiments, the shape detecting unit 155 may detect a specified shape (e.g., an omega shape) using a method of determining a characteristic of feature points, such as, for example, a local binary pattern (LBP) or a modified census transform (MCT). The shape detecting unit 155 may set a sub-region in the detection region and may perform a scan (e.g., a zigzag scan) for the detection region for each sub-region. The shape detecting unit 155 may convert a size of each of feature point included in the sub-region, and may determine whether a pattern corresponding to the specified shape is present in the sub-region. Also, the shape detecting unit 155 may set the sub-region to be gradually larger in size and may proceed with detection.

According to various embodiments, the electronic device 100 may convert a size of a pattern of a minimum size, corresponding to the specified shape, based on a size of the sub-region, and may compare the converted pattern with a pattern of the feature points. The shape detecting unit 155 may scan all set detection regions. However, if the specified shape is detected, the shape detecting unit 155 stops scanning the set detection regions. Also, the shape detecting unit 155 may send information indicating whether the specified shape is detected to the exposure configuration unit 157 or the face detecting unit 159.

The exposure configuration unit 157 may set at least one of an aperture value, a shutter speed, or sensitivity of the image sensor 117 of FIG. 1. If the specified shape is detected, the exposure configuration unit 157 may change an exposure configuration. According to various embodiments, the exposure configuration unit 157 may change an exposure configuration in different ways based on a distribution state of feature points included in the specified shape (e.g., the number of the feature points, a distribution level of the feature points, or density of the feature points).

According to an embodiment, when the number of the feature points included in the specified shape is reduced, the exposure configuration unit 157 may set an exposure increase range to be larger. For example, the exposure configuration unit 157 may set a reduction range of an aperture value to be larger, may set a reduction range of a shutter speed to be larger, or may set a sensitivity increase range of the image sensor 117 to be larger. When the number of the feature points included in the specified shape is increased, the exposure configuration unit 157 may set an exposure increase range to be smaller. For example, the exposure configuration unit 157 may set a reduction range of an aperture value to be smaller, may set a reduction range of a shutter speed to be smaller, or may set a sensitivity increase range of the image sensor 117 to be smaller. If a luminance value of the image is greater than a specified level, the exposure configuration unit 157 may reduce exposure rather than increase exposure.

The face detecting unit 159 may determine whether a face of a person is present on the image. The face detecting unit 159 may scan the image for each sub-region of a specified size and may determine whether a pattern corresponding to the face is present. According to an embodiment, the face detecting unit 159 may determine whether a face is present on the image based on image data of a face, stored in the memory 130 of FIG. 1.

The function of determining whether the pattern corresponding to the face is present at the face detecting unit 159 may be the same or similar to a function of determining whether a specified shape is present at the shape detecting unit 155. For example, the face detecting unit 159 may compare image data corresponding to the sub-region with image data of a face stored in the memory 130 to determine whether a face is present. In this case, the face detecting unit 159 may set the sub-region to be gradually larger in size and may proceed with detection. The face detecting unit 159 may convert a size of image data of a face stored in the memory 130 based on a size of the sub-region and may compare the converted image data of the face.

According to various embodiments, the processor 150 may further include a backlight determining unit, which may determine whether the image is an image photographed in a backlight condition. For example, the backlight determining unit may classify the image into a plurality of regions, and may classify the regions into a center region and a peripheral region. Also, the backlight determining unit may calculate a luminance characteristic value for each of the plurality of regions. The luminance characteristic value may be one of the sum of luminance values in which luminance values of pixels in each of the plurality of regions are added, an average luminance value of pixels in each of the plurality of regions, or a pixel luminance representative value representing luminance values of pixels in each of the plurality of regions. The backlight determining unit may compare luminance characteristic values of the plurality of regions and may determine a backlight state based on the compared result. If a value in which the sum of luminance values in the center region is subtracted from the sum of luminance values in the peripheral region is greater than or equal to a specified level, the backlight determining unit may determine the image as the image photographed in the backlight condition. If the image is the image photographed in the backlight condition, the processor 150 may perform the above-described face detection function.

According to an embodiment of the present disclosure, the processor 150 includes the feature point extracting unit 151, the detection region determining unit 153, the shape detecting unit 155, the exposure configuration unit 157, and the face detecting unit 159. The processor 150 is not limited thereto. According to various embodiments, the processor 150 may perform instructions, corresponding to functions of the feature point extracting unit 151, the detection region determining unit 153, the shape detecting unit 155, the exposure configuration unit 157, and the face detecting unit 159, implemented in the form of a program in the memory 130.

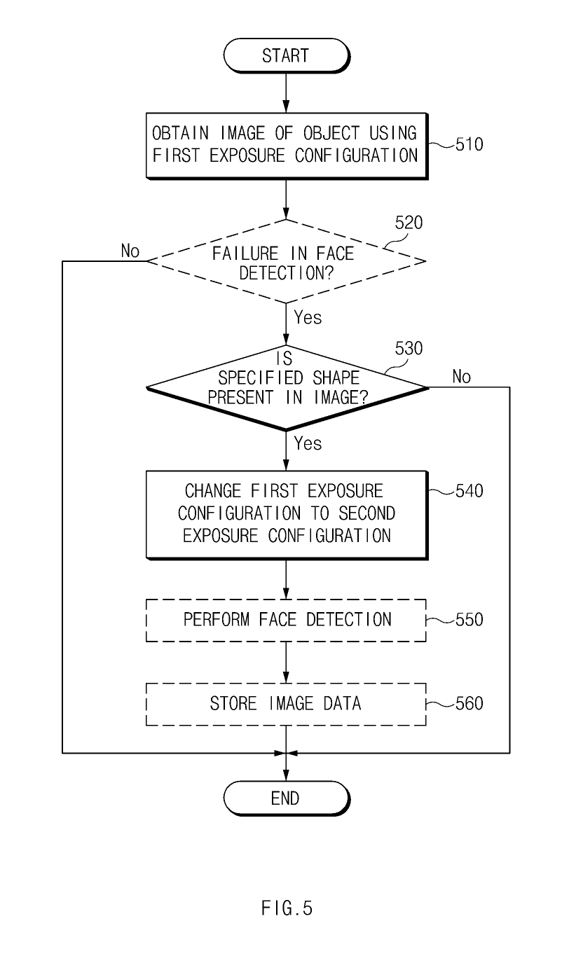

FIG. 5 is a flowchart illustrating an operation method of an electronic device associated with face detection, according to an embodiment of the present disclosure.

Referring to FIG. 5, in step 510, the electronic device 100 of FIG. 1 obtains a first image by photographing an object using a first exposure configuration. According to various embodiments, the electronic device 100 may determine whether the first image is an image photographed in a backlight condition. If the first image is not photographed in the backlight condition, the electronic device 100 may steps 520 to 560 described below.

In step 520, the electronic device 100 performs face detection from the first image. According to various embodiments, if the face detection from the first image succeeds, the electronic device 100 may omit steps 530 to 560 described below. Alternatively, the electronic device 100 may omit steps 530 to 550, and may perform step 560.

According to various embodiments, if the face detection from the first image fails, the electronic device 100 determines whether a specified shape is present in the first image, in step 530. The electronic device 100 may determine whether an omega shape corresponding to a face shape is present in the first image.

According to various embodiments, if the specified shape is not present in the first image, the electronic device 100 may omit steps 540 to 560 described below. If the specified shape is present in the first image, the electronic device 100 changes the first exposure configuration to a second exposure configuration, in step 540. The second exposure configuration may be a configuration in which an exposure is relatively increased than the first exposure configuration. For example, in the second exposure configuration, an aperture value is relatively reduced from that of the first exposure configuration, a shutter speed may be reduced from that of the first exposure configuration, or sensitivity of the image sensor 117 of FIG. 1 may be increased from that of the first exposure configuration.

According to various embodiments, the electronic device 100 may change the second exposure configuration in a different way based on a distribution state of feature points that are present in the specified shape included in the first image. When there are a reduced number of the feature points present in the specified shape, the electronic device 100 may set an exposure increase range of the second exposure configuration to be larger than the first exposure configuration,

According to various embodiments, the electronic device 100 may obtain a second image by photographing an object using the changed second exposure configuration. Also, in step 550, the electronic device 100 performs face detection from the second image. Therefore, the electronic device 100 may detect a face from the second image due to an increase in exposure. If the face detection from the second image fails, the electronic device 100 may change the second exposure configuration to a third exposure configuration to increase an exposure. For example, if face detection fails although a specified shape is present in an image, the electronic device 100 may repeatedly perform steps 520 to 550 until succeeding in face detection. Alternatively, the electronic device 100 may limit operations 520 to 550 to be performed a specified number of times.

In step 560, the electronic device 100 stores image data corresponding to the face in the memory 130 of FIG. 1. According to various embodiments, the electronic device 100 may store image data corresponding to an omega shape in the first image as a face image data in a backlight condition. Also, the electronic device 100 may store image data corresponding to an omega shape in the second image as face image data in a general condition.

According to various embodiments, the electronic device 100 may not perform at least one of steps 520, 550, and 560. For example, the electronic device 100 may omit performance of face detection from an image where an object is photographed, may determine whether the specified shape is present, and may change an exposure configuration.

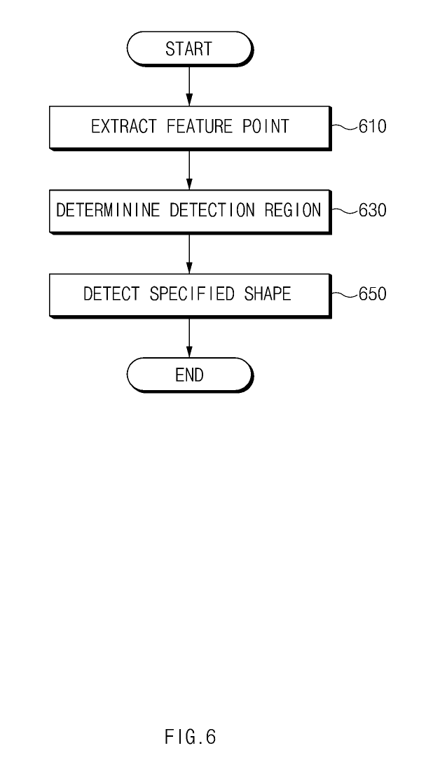

FIG. 6 is a flowchart illustrating an operation method of an electronic device associated with detecting a specified shape from an image, according to an embodiment of the present disclosure.

Referring to FIG. 6, in step 610, the electronic device 100 of FIG. 1 extracts feature points from a photographed image. According to an embodiment, the electronic device 100 may extract corner points or boundary points of each object included in the image as the feature points. The electronic device 100 may extract the feature points from the image based on luminance information of the image. For example, if a variation level of a luminance value is greater than a specific level, the electronic device 100 may extract a corresponding point as a feature point.

In step 630, the electronic device 100 determines a detection region. According to various embodiments, if the feature points are extracted from the image, the electronic device 100 may determine a region where the feature points are present as a detection region. According to an embodiment, if the feature points are present within a specified separation distance, the electronic device 100 may determine the region where the feature points are present as one detection region.

In step 650, the electronic device 100 detects a specified shape. According to an embodiment, the electronic device 100 may determine whether the specified shape (e.g., an omega shape) is present in the detection region. For example, the electronic device 100 may determine whether feature points included in the detection region are distributed as the specified shape. The electronic device 100 may convert a size of each of feature point included in a sub-region while scanning the detection region for each sub-region, and may determine whether a pattern corresponding to the specified shape is present. Also, if the scan of the detection region for each sub-region is ended, the electronic device 100 may set the sub-region to be larger in size and may detect the specified shape again. Also, the electronic device 100 may set the sub-region to be gradually larger in size until the sub-region is the same size as or similar in size to the detection region and may detect the specified shape.

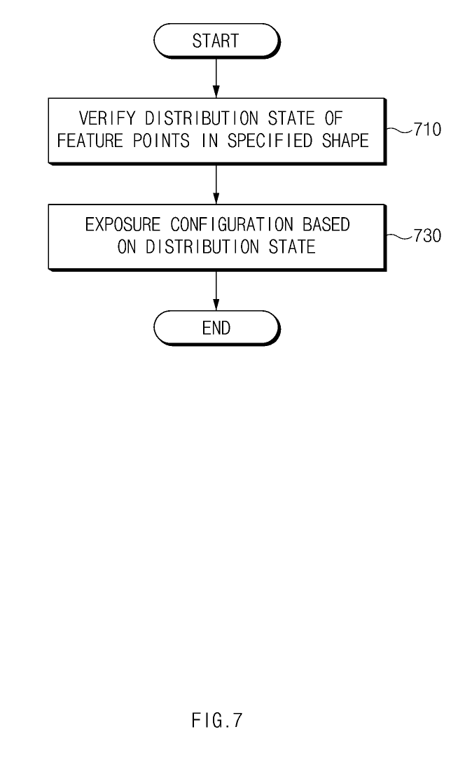

FIG. 7 is a flowchart illustrating an operation method of an electronic device associated with changing an exposure configuration, according to an embodiment of the present disclosure. The electronic device 100 of FIG. 1 may change an exposure configuration in a different way based on a distribution state of feature points that are present in a specified shape included in an image when changing the exposure configuration.

Referring to FIG. 7, in step 710, the electronic device 100 verifies the distribution state of the feature points in the specified shape. According to an embodiment, the electronic device 100 may analyze the number of feature points in the specified shape, a distribution level of the feature points, a density of the feature points, and the like. If the specified shape is an omega shape, the electronic device 100 may verify the number of feature points included in an upper side (e.g., a region corresponding to eyes, a noise, or a mouth of a face) in the omega shape.

In step 730, the electronic device 100 sets an exposure based on the distribution state of the feature points. According to an embodiment, when the number of the feature points included in the upper side in the omega shape is lower, the electronic device 100 may set an exposure increase range to be larger. For example, the electronic device 100 may set a reduction range of an aperture value to be larger, may set a reduction range of a shutter speed to be larger, or may set a sensitivity increase range of an image sensor 117 of FIG. 1 to be larger. When the number of the feature points included in the upper side in the omega shape is higher, the electronic device 100 may set an exposure increase range to be smaller. For example, the electronic device 100 may set a reduction range of an aperture value to be smaller, may set a reduction range of a shutter speed to be smaller, or may set a sensitivity increase range of the image sensor 117 to be smaller.

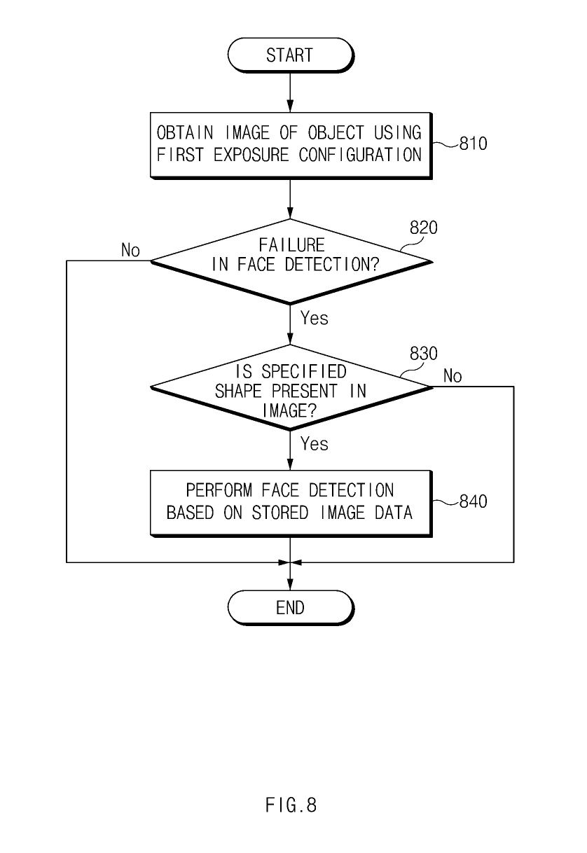

FIG. 8 is a flowchart illustrating an operation method of an electronic device associated with face detection using stored image data, according to an embodiment of the present disclosure. If a specified shape (e.g., an omega shape) is present in an image photographed in a backlight condition, the electronic device 100 of FIG. 1 may perform face detection based on face image data stored in the memory 130 of FIG. 1 rather than changing an exposure configuration.

Referring to FIG. 8, in step 810, the electronic device 100 obtains a first image by photographing an object using a first exposure configuration. In step 820, the electronic device 100 preforms face detection from the first image and it is determined whether face detection fails. According to various embodiments, if the face detection succeeds, the electronic device 100 may omit to steps 830 and 840 described below.

According to various embodiments, if the face detection fails, the electronic device 100 determines whether a specified shape is present in the first image, in step 830. The electronic device 100 may determine whether an omega shape corresponding to a face shape of a person is present in the first image. If the specified shape is not present in the first image, the electronic device 100 may omit step 840.

According to various embodiments, if the specified shape is present in the first image, the electronic device 100 performs face detection based on image data stored in the memory 130, in step 840. The electronic device 100 may perform the face detection from the first image using face image data in a backlight condition, stored in the memory 130. For example, the electronic device 100 may calculate similarity between image data corresponding to the specified shape in the first image and face image data in the backlight condition. If the similarity is greater than or equal to a specified level, the electronic device 100 may detect part of an image corresponding to the specified shape as a face.

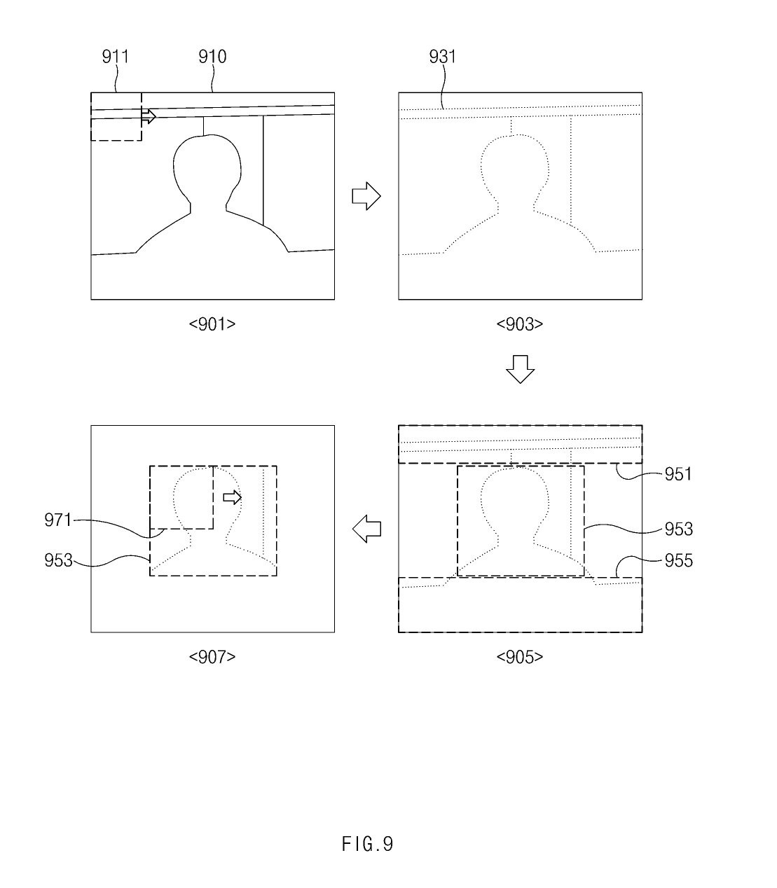

FIG. 9 is a diagram illustrating detection of a specified shape from an image, according to an embodiment of the present disclosure.

Referring to FIG. 9, in first state 901, the electronic device 100 of FIG. 1 obtains a first image 910 by photographing an object using a first exposure configuration. Also, the electronic device 100 scans the first image 910 in a specified direction and extracts feature points 931 in second state 903. In this case, the electronic device 100 may divide the first image 910 into at least one sub-region 911 and may sequentially scan the at least one divided sub-region 911 in the specified direction. According to various embodiments, the electronic device 100 may extract the feature points from the first image 910 based on luminance information of the first image 910.

If the feature points 931 are extracted, in third state 905, the electronic device 100 may set a detection region. According to an embodiment, the electronic device 100 may set the feature points 931, which are present within a specified separation distance, to one detection region. In FIG. 9, an embodiment of the present disclosure is exemplified as the electronic device 100 combines the feature points 931 which are present in an upper region of the first image 910 and sets the combined region to a first detection region 951, combines the feature points 931 which are present in a central region of the first image 910 and sets the combined region to a second detection region 953, and combines the feature points 931 which are present in a lower region of the first image 910 and sets the combined region to a third detection region 955.

According to various embodiments, if the first to third detection regions 951, 953, and 955 are set, in fourth state 907, the electronic device 100 may detect a specified shape in each of the first to third detection regions 951, 953, and 955. For example, the electronic device 100 may divide the second detection region 953 into at least one sub-region 971 and may detect the specified shape while sequentially scanning the at least one divided sub-region 971 in a specified direction. In FIG. 9, an embodiment of the present disclosure is exemplified as the electronic device 100 detects the specified shape in the second detection region 953. Embodiments of the present disclosure are not limited thereto. For example, the electronic device 100 may detect the specified shape in the first detection region 951 and the third detection region 955.

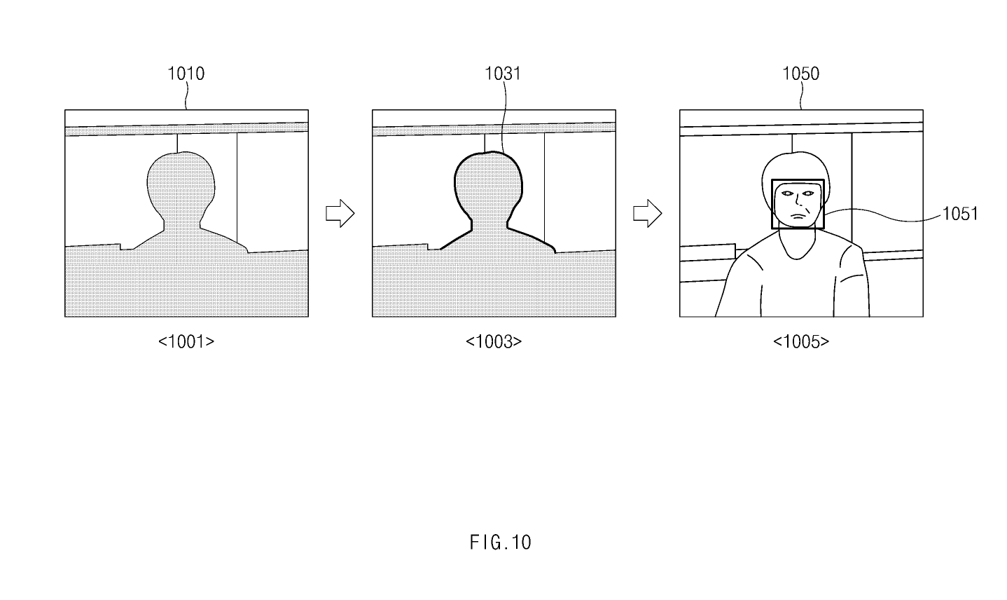

FIG. 10 is a screen illustrating an operation of changing an exposure configuration and detecting a face, according to an embodiment of the present disclosure.

Referring to FIG. 10, in state 1001, the electronic device 100 of FIG. 1 obtains a first image 1010 by photographing an object using a first exposure configuration. According to various embodiments, the electronic device 100 may determine whether the first image 1010 is an image photographed in a backlight condition. The electronic device 100 determines whether the first image 1010 is photographed in the backlight condition based on luminance information of the first image 1010.

If the first image 1010 is the image photographed in the backlight condition, in second state 1003, the electronic device 100 detects a specified shape 1031 (e.g., an omega shape) from the first image 1010. According to an embodiment, the electronic device 100 may extract feature points from the first image 1010, may analyze a pattern of the feature points, and may detect the specified shape 1031.

If the specified shape 1031 is detected from the first image 1010, the electronic device 100 may change the first exposure configuration to a second exposure configuration. Also, in third state 1005, the electronic device 100 obtains a second image 1050 by photographing the object using the second exposure configuration.

According to various embodiments, if obtaining the second image 1050, the electronic device 100 may perform face detection from the second image 1050. Also, when outputting the second image 1050 on the display 170 of FIG. 1, the electronic device 100 may apply a specified effect to a face region 1051 detected from the second image 1050. In FIG. 10, an embodiment of the present disclosure is exemplified as the electronic device 100 displays an object having a quadrangular periphery on the detected face region 1051. However, the effect applied to the detected face region 1051 is not limited thereto. The electronic device 100 may display an object having a circular or oval periphery to the detected face region 1051 and may set a color of the displayed object in a different way.

According to various embodiments, if the first image 1010 in which the object is photographed is a preview image or a live-view image, the electronic device 100 may continuously perform the above-mentioned face detection function and may track the face region 1051 on the first image 1010 changed based on motion of the object. Also, if a location or size and the like of the face region 1051 is changed, the electronic device 100 may change a location, size, or color of the object displayed on the face region 1051 and may display the changed object.

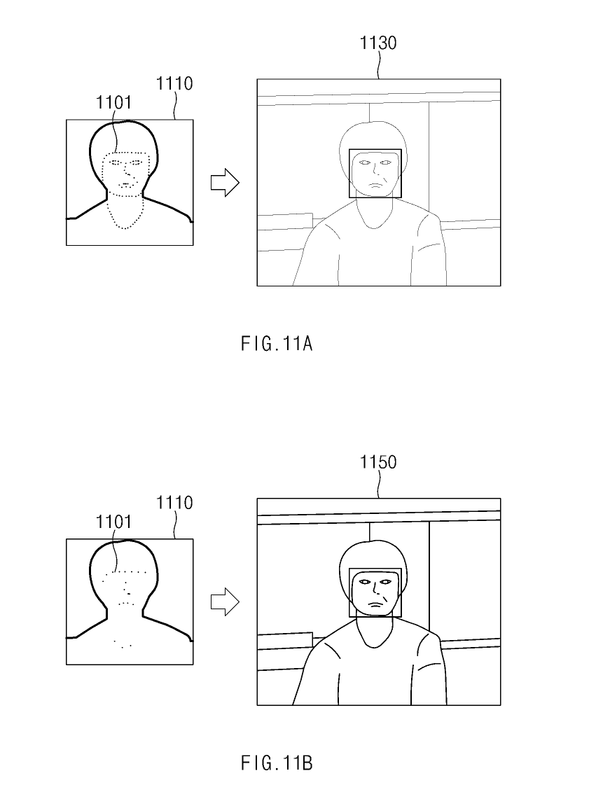

FIG. 11A is a drawing illustrating an exposure configuration based on a distribution state of feature points in a specified shape, according to an embodiment of the present disclosure. FIG. 11B is a drawing illustrating an exposure configuration based on a distribution state of feature points in a specified shape, according to an embodiment of the present disclosure.

According to various embodiments, the electronic device 100 of FIG. 1 determines whether a first image 1110 in which an object is photographed using a first exposure configuration is an image photographed in a backlight condition. If the first image 1110 is the image photographed in the backlight condition, the electronic device 100 may detect a specified shape from the first image 1110. If the specified shape is detected from the first image 1110, the electronic device 100 may change the first exposure configuration to a second exposure configuration.

According to various embodiments, when changing the first exposure configuration to the second exposure configuration, the electronic device 100 may change the second exposure configuration in a different way based on a distribution state of feature points 1101 that are present in the specified shape (e.g., the number of the feature points 1101, a distribution level of the feature points 1101, or density of the feature points 1101, and the like). The electronic device 100 may change the second exposure configuration in a different way based on the number of the feature points 1101 that are present in a region (e.g., an upper side) in the specified shape.

As shown in FIG. 11A, if there is the specified number of the feature points 1101 or more present in an omega shape, the electronic device 100 changes the second exposure configuration such that an exposure is higher than the first exposure configuration by a first level. Also, as shown in FIG. 11B, if there is less than the specified number of the feature points 1101 present in the omega shape, the electronic device 100 changes the second exposure configuration such that an exposure is higher than the first exposure configuration by a second level. Herein, the first level may be relatively lower than the second level. For example, when the number of the feature points 1101 present in the omega shape is higher, the electronic device 100 may set an exposure increase range to be smaller. When the number of the feature points 1101 which are present in the omega shape is lower, the electronic device 100 may set an exposure increase range to be larger. Therefore, a second image 1130 in which the object is photographed using the second exposure configuration in FIG. 11A may be relatively darker than a third image 1150 in which the object is photographed using the second exposure configuration in FIG. 11B. However, the exposure increase range of the second exposure configuration is not limited thereto. In various embodiments, when the number of the feature points 1101 which are present in the omega shape is higher, the electronic device 100 may set an exposure increase range to be larger.

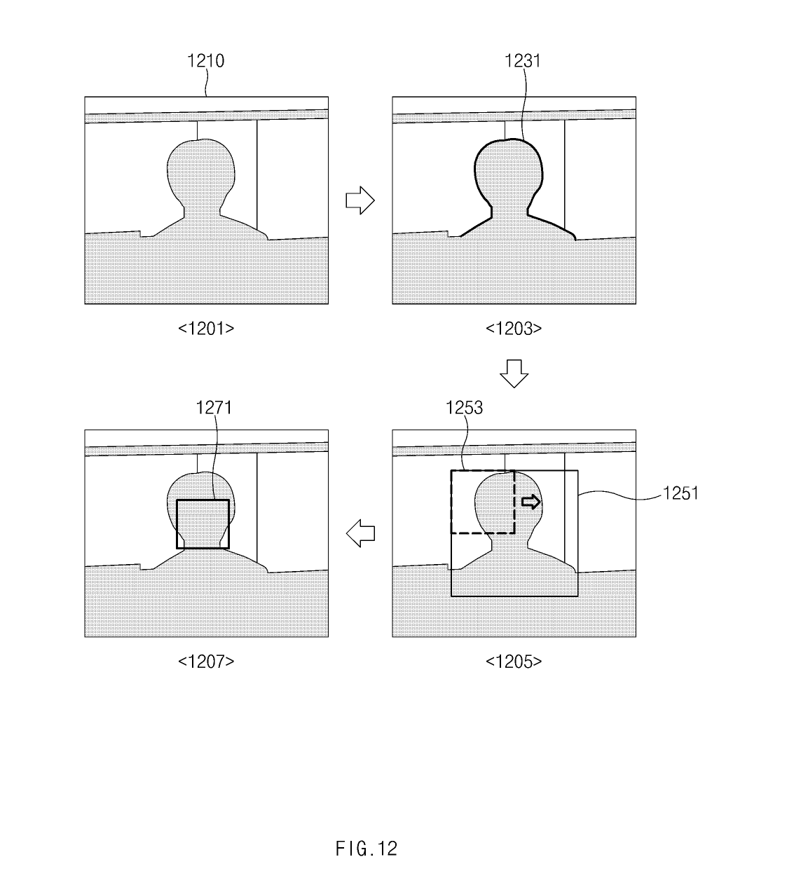

FIG. 12 is a screen illustrating an operation of detecting a face using stored image data, according to an embodiment of the present disclosure. According to various embodiments, if a specified shape is present in an image photographed in a backlight condition, the electronic device 100 of FIG. 1 detects a face using face image data stored in the memory 130 of FIG. 1 rather than changing an exposure configuration.

Referring to FIG. 12, in a first state 1201, the electronic device 100 obtains a first image 1210 by photographing an object using a first exposure configuration. Also, the electronic device 100 performs face detection from the first image 1210.

According to various embodiments, if the face detection of the first image 1210 fails, in a second state 1203, the electronic device 100 detects a specified shape 1231 (e.g., an omega shape) from the first image 1210. The electronic device 100 extracts feature points from the first image 1210, analyzes a pattern of the feature points, and detects the specified shape 1231.

According to various embodiments, if the specified shape 1231 is detected from the first image 1210, in a third state 1205, the electronic device 100 may perform face detection based on face image data stored in the memory 130. The electronic device 100 performs face detection in only a region 1251 where the specified shape 1231 is detected. For example, the electronic device 100 may divide the region 1251 where the specified shape 1231 is detected into at least one sub-region 1253, and may perform face detection while sequentially scanning the at least one divided sub-region 1253 in a specified direction.

According to various embodiments, the electronic device 100 compares face image data in a backlight condition among face image data stored in the memory 130 with data of part of the first image 1210 corresponding to the region 1251 where the specified shape 1231 is detected. If similarity between the face image data and the data of the part of the first image 1210 is greater than or equal to a specific level, the electronic device 100 detects part of the first image 1210, corresponding to the region 1251 where the specified shape 1231 is detected, as a face region 1271.

According to various embodiments, in fourth stale 1207, the electronic device 100 applies a specified effect to the face region 1271 in the first image output on a display 170 of FIG. 1. In FIG. 12, the electronic device 100 displays an object having a quadrangular periphery on the face region 1271. However, the effect applied to the face region 1271 is not limited thereto. The electronic device 100 may display an object having a circular or oval periphery on the face region 1271 and may set a color of the displayed object in a different way.

According to various embodiments, if the first image 1210 in which the object is photographed is a preview image or a live-view image, the electronic device 100 may continuously perform the above-described face detection function and may track the face region 1271 on the first image 1210 changed based on motion of the object. Also, if a location or size and the like of the detected face region 1271 are changed, the electronic device 100 may change a location, size, or color of the object displayed on the face region 1271 and may display the changed object.

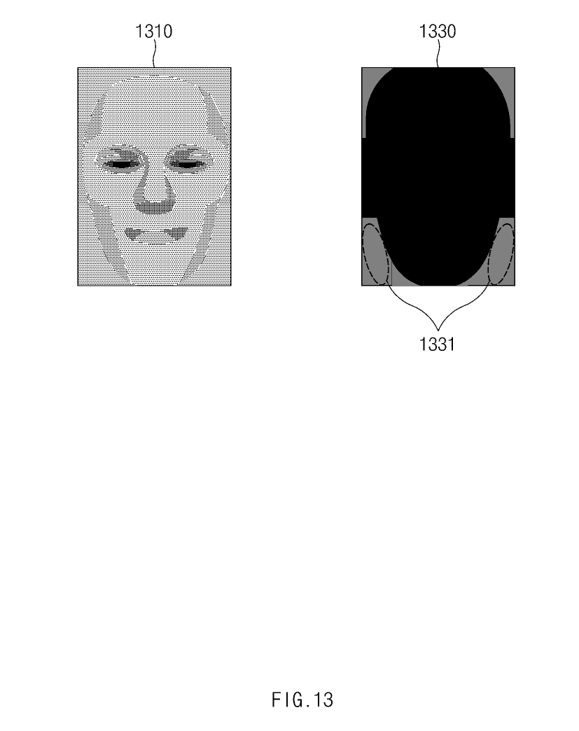

FIG. 13 is a drawing illustrating a pattern in which a face shape is stored, according to an embodiment of the present disclosure.

Referring to FIG. 13, the electronic device 100 of FIG. 1 stores face image data corresponding to a face shape in the memory 130 of FIG. 1. According to various embodiments, if a face is detected from an image in which an object is photographed, the electronic device 100 stores face image data, corresponding to a region where the face is detected, in the memory 130. When storing the face image data, the electronic device 100 classifies and stores a direction of the face, for example, a front surface, a right side surface, or a left side surface of the face in the memory 130. Also, when storing the face image data, the electronic device 100 may change a size of the face to the same size as or a similar size to that of previously stored face image data, and may store the changed face image data in the memory 130. The electronic device 100 may store a mean value of face image data in the memory 130. For example, the electronic device 100 may calculate a mean value of previously stored face image data and a mean value of face image data to be newly stored, and may store the calculated mean values in the memory 130.

According to various embodiments, the electronic device 100 classifies and stores first face image data 1310 in a general condition and second face image data 1330 in a backlight condition in the memory 130. When using the face image data 1330 in the backlight condition, the electronic device 100 verifies whether there is a region 1331 (e.g., a space which is present between a face and a shoulder) aside from a face region, and may determine the face region.

According to various embodiments of the present disclosure, the electronic device may perform face detection in a backlight condition by changing an exposure configuration if a specified shape is detected from an image in which an object is photographed.

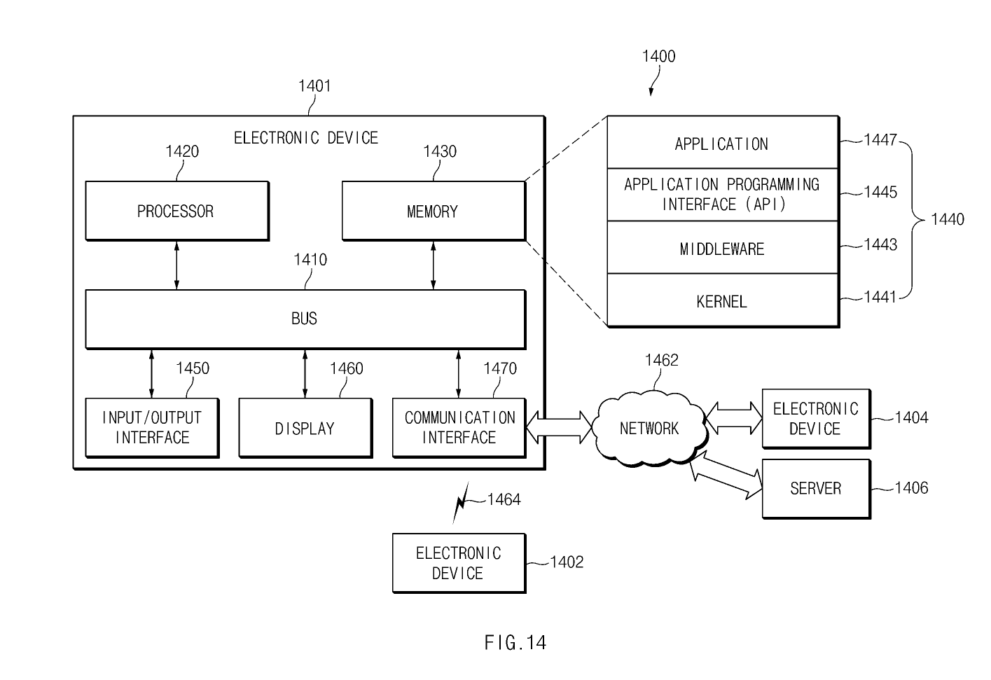

FIG. 14 is a diagram illustrating an electronic device in a network environment, according to an embodiment of the present disclosure.

An electronic device 1401 in a network environment 1400 is described with reference to FIG. 14. The electronic device 1401 includes a bus 1410, a processor 1420, a memory 1430, an input/output interface 1450, a display 1460, and a communication interface 1470. In various embodiments of the present disclosure, at least one of the foregoing elements may be omitted or another element may be added to the electronic device 1401.

The bus 1410 may include a circuit for connecting the above-described elements 1410 to 1470 to each other and transferring communications (e.g., control messages and/or data) among the above-mentioned elements.

The processor 1420 may include at least one of a CPU, an AP, or a CP. The processor 1420 may perform data processing or an operation related to communication and/or control of at least one of the other elements of the electronic device 1401.

The memory 1430 may include a volatile memory and/or a nonvolatile memory. The memory 1430 may store instructions or data related to at least one of the other elements of the electronic device 1401. According to an embodiment of the present disclosure, the memory 1430 may store software and/or a program 1440. The program 1440 includes, for example, a kernel 1441, a middleware 1443, an application programming interface (API) 1445, and an application program (or an application) 1447. At least a portion of the kernel 1441, the middleware 1443, or the API 1445 may be referred to as an operating system (OS).

The kernel 1441 may control or manage system resources (e.g., the bus 1410, the processor 1420, the memory 1430, or the like) used to perform operations or functions of other programs (e.g., the middleware 1443, the API 1445, or the application program 1447). Furthermore, the kernel 1441 may provide an interface for allowing the middleware 1443, the API 1445, or the application program 1447 to access individual elements of the electronic device 1401 in order to control or manage the system resources.

The middleware 1443 may serve as an intermediary so that the API 1445 or the application program 1447 communicates and exchanges data with the kernel 1441.

Furthermore, the middleware 1443 may handle one or more task requests received from the application program 1447 according to a priority order. For example, the middleware 1443 may assign at least one application program 1447 a priority for using the system resources (e.g., the bus 1410, the processor 1420, the memory 1430, or the like) of the electronic device 1401. For example, the middleware 1443 may handle the one or more task requests according to the priority assigned to the at least one application, thereby performing scheduling or load balancing with respect to the one or more task requests.

The API 1445, which is an interface for allowing the application 1447 to control a function provided by the kernel 1441 or the middleware 1443, may include, for example, at least one interface or function (e.g., instructions) for file control, window control, image processing, character control, or the like.

The input/output interface 1450 may serve to transfer an instruction or data input from a user or another external device to (an) other element(s) of the electronic device 1401. Furthermore, the input/output interface 1450 may output instructions or data received from (an) other element(s) of the electronic device 1401 to the user or another external device.

The display 1460 may include, for example, a LCD, a LED display, an OLED display, a MEMS display, or an electronic paper display. The display 1460 may present various content (e.g., a text, an image, a video, an icon, a symbol, or the like) to the user. The display 1460 may include a touch screen, and may receive a touch, gesture, proximity or hovering input from an electronic pen or a part of a body of the user.

The communication interface 1470 may set communications between the electronic device 1401 and an external device (e.g., a first external electronic device 1402, a second external electronic device 1404, or a server 1406). For example, the communication interface 1470 may be connected to a network 1462 via wireless communications or wired communications so as to communicate with the external device (e.g., the second external electronic device 1404 or the server 1406).

The wireless communications may employ at least one of cellular communication protocols such as long-term evolution (LTE), LTE-advance (LTE-A), code division multiple access (CDMA), wideband CDMA (WCDMA), universal mobile telecommunications system (UMTS), wireless broadband (WiBro), or global system for mobile communications (GSM). The wireless communications may include, for example, a short-range communications 1464. The short-range communications may include at least one of wireless fidelity (Wi-Fi), Bluetooth, near field communication (NFC), magnetic stripe transmission (MST), or GNSS.

The MST may generate pulses according to transmission data and the pulses may generate electromagnetic signals. The electronic device 1401 may transmit the electromagnetic signals to a reader device such as a POS device. The POS device may detect the magnetic signals by using a MST reader and restore data by converting the detected electromagnetic signals into electrical signals.

The GNSS may include, for example, at least one of global positioning system (GPS), global navigation satellite system (GLONASS), BeiDou navigation satellite system (BeiDou), or Galileo, the European global satellite-based navigation system according to a use area or a bandwidth. Hereinafter, the term “GPS” and the term “GNSS” may be interchangeably used. The wired communications may include at least one of universal serial bus (USB), high definition multimedia interface (HDMI), recommended standard 832 (RS-232), plain old telephone service (POTS), or the like. The network 1462 may include at least one of telecommunications networks, for example, a computer network (e.g., local area network (LAN) or wide area network (WAN)), the Internet, or a telephone network.

The types of the first external electronic device 1402 and the second external electronic device 1404 may be the same as or different from the type of the electronic device 1401. According to an embodiment of the present disclosure, the server 1406 may include a group of one or more servers. A portion or all of the operations performed in the electronic device 1401 may be performed in one or more other electronic devices (e.g., the first external electronic device 1402, the second external electronic device 1404, or the server 1406). When the electronic device 1401 should perform a certain function or service automatically or in response to a request, the electronic device 1401 may request at least a portion of functions related to the function or service from another device (e.g., the first external electronic device 1402, the second external electronic device 1404, or the server 1406) instead of or in addition to performing the function or service for itself. The other electronic device (e.g., the first external electronic device 1402, the second external electronic device 1404, or the server 1406) may perform the requested function or additional function, and may transfer a result of the performance to the electronic device 1401. The electronic device 1401 may use a received result itself or additionally process the received result to provide the requested function or service. To this end, for example, a cloud computing technology, a distributed computing technology, or a client-server computing technology may be used.

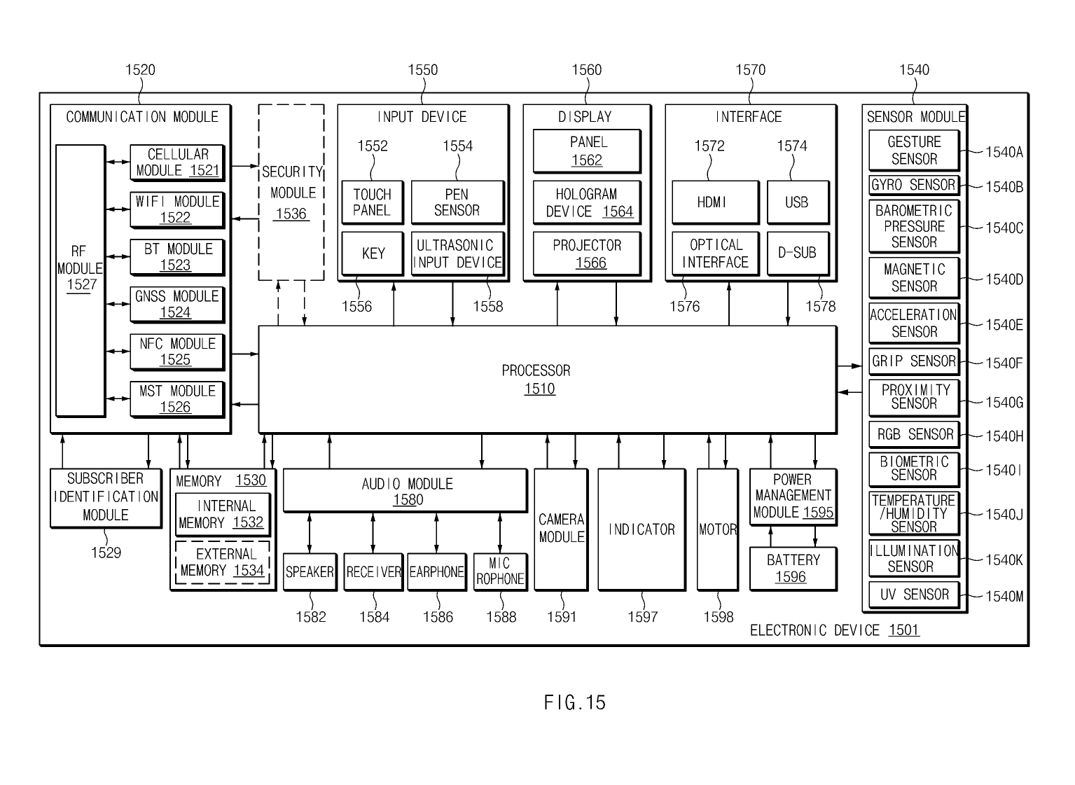

FIG. 15 is a block diagram illustrating a configuration of an electronic device, according to an embodiment of the present disclosure.

Referring to FIG. 15, an electronic device 1501 may include, for example, all or part of the electronic device 1401 of FIG. 14. The electronic device 1501 may include one or more processors 1510 (e.g., APs), a communication module 1520, a subscriber identification module (SIM) 1529, a memory 1530, a security module 1536, a sensor module 1540, an input device 1550, a display 1560, an interface 1570, an audio module 1580, a camera module 1591, a power management module 1595, a battery 1596, an indicator 1597, and a motor 1598.

The processor 1510 may drive, for example, an OS or an application program to control a plurality of hardware or software components connected thereto and may process and compute a variety of data. The processor 1510 may be implemented with, for example, a system on chip (SoC). According to an embodiment of the present disclosure, the processor 1510 may include a graphic processing unit (GPU) and/or an image signal processor. The processor 1510 may include at least some of the components (e.g., a cellular module) shown in FIG. 15. The processor 1510 may load a command or data received from at least one of other components (e.g., a non-volatile memory) into a volatile memory to process the data and may store various data in a non-volatile memory.

The communication module 1520 may have the same or similar configuration to the communication interface 1470 of FIG. 14. The communication module 1520 includes, for example, a cellular module 1521, a Wi-Fi module 1522, a BT module 1523, a GNSS module 1524 (e.g., a GPS module, a Glonass module, a Beidou module, or a Galileo module), a NFC module 1525, an MST module 1526, and a radio frequency (RF) module 1527.

The cellular module 1521 may provide, for example, a voice call service, a video call service, a text message service, or an Internet service, and the like through a communication network. According to an embodiment of the present disclosure, the cellular module 1521 may identify and authenticate the electronic device 1501 in a communication network using the SIM 1529 (e.g., a SIM card). According to an embodiment of the present disclosure, the cellular module 1521 may perform at least part of functions which may be provided by the processor 1510. According to an embodiment of the present disclosure, the cellular module 1521 may include a CP.

The Wi-Fi module 1522, the BT module 1523, the GNSS module 1524, the NFC module 1525, or the MST module 1526 may include, for example, a processor for processing data transmitted and received through the corresponding module. According to various embodiments of the present disclosure, at least some (e.g., two or more) of the cellular module 1521, the Wi-Fi module 1522, the BT module 1523, the GNSS module 1524, the NFC module 1525, or the MST module 1526 may be included in one integrated circuit (IC) or one IC package.

The RF module 1527 may transmit and receive, for example, a communication signal (e.g., an RF signal). Though not shown, the RF module 1527 may include, for example, a transceiver, a power amplifier module (PAM), a frequency filter, or a low noise amplifier (LNA), or an antenna, and the like. According to another embodiment of the present disclosure, at least one of the cellular module 1521, the Wi-Fi module 1522, the BT module 1523, the GNSS module 1524, the NFC module 1525, or the MST module 1526 may transmit and receive an RF signal through a separate RF module.

The SIM 1529 may include, for example, a card which includes a SIM and/or an embedded SIM. The SIM 1529 may include unique identification information (e.g., an integrated circuit card identifier (ICCID)) or subscriber information (e.g., an international mobile subscriber identity (IMSI)).

The memory 1530 (e.g., the memory 1430 of FIG. 14) includes, for example, an embedded memory 1532 and an external memory 1534. The embedded memory 1532 may include at least one of, for example, a volatile memory (e.g., a dynamic random access memory (RAM) (DRAM), a static RAM (SRAM), a synchronous dynamic RAM (SDRAM), and the like), or a non-volatile memory (e.g., a one-time programmable read only memory (ROM) (OTPROM), a programmable ROM (PROM), an erasable and programmable ROM (EPROM), an electrically erasable and programmable ROM (EEPROM), a mask ROM, a flash ROM, a flash memory (e.g., a NAND flash memory or a NOR flash memory, and the like), a hard drive, or a solid state drive (SSD)).

The external memory 1534 may include a flash drive, for example, a compact flash (CF), a secure digital (SD), a micro-SD, a mini-SD, an extreme digital (xD), a multimedia car (MMC), or a memory stick, and the like. The external memory 1534 may operatively and/or physically connect with the electronic device 1501 through various interfaces.

The security module 1536 may be a module which has a relatively higher security level than the memory 1530, and may be a circuit which stores secure data and guarantees a protected execution environment. The security module 1536 may be implemented with a separate circuit and may include a separate processor. The security module 1536 may include, for example, an embedded secure element (eSE), which is present in a removable smart chip or a removable SD card or is embedded in a fixed chip of the electronic device 1501. Also, the security module 1536 may be driven by an OS different from the OS of the electronic device 1501. For example, the security module 1536 may operate based on a java card open platform (JCOP) OS.

The sensor module 1540 may measure, for example, a physical quantity or may detect an operation state of the electronic device 1501, and may convert the measured or detected information to an electric signal. The sensor module 1540 includes at least one of, for example, a gesture sensor 1540A, a gyro sensor 1540B, a barometric pressure sensor 1540C, a magnetic sensor 1540D, an acceleration sensor 1540E, a grip sensor 1540F, a proximity sensor 1540G, a color sensor 1540H (e.g., red, green, blue (RGB) sensor), a biometric sensor 1540I, a temperature/humidity sensor 1540J, an illumination sensor 1540K, or an ultraviolet (UV) sensor 1540M. Additionally or alternatively, the sensor module 1540 may further include, for example, an e-nose sensor, an electromyography (EMG) sensor, an electroencephalogram (EEO) sensor, an electrocardiogram (ECG) sensor, an infrared (IR) sensor, an iris sensor, and/or a fingerprint sensor, and the like. The sensor module 1540 may further include a control circuit for controlling at least one or more sensors included therein. According to various embodiments of the present disclosure, the electronic device 1501 may further include a processor configured to control the sensor module 1540, as part of or independent from the processor 1510. While the processor 1510 is in a sleep state, the electronic device 1501 may control the sensor module 1540.

The input device 1550 includes, for example, a touch panel 1552, a (digital) pen sensor 1554, a key 1556, and an ultrasonic input device 1558. The touch panel 1552 may use at least one of, for example, a capacitive type, a resistive type, an infrared type, or an ultrasonic type. Also, the touch panel 1552 may further include a control circuit. The touch panel 1552 may further include a tactile layer and may provide a tactile reaction to a user.

The (digital) pen sensor 1554 may be, for example, part of the touch panel 1552 or may include a separate sheet for recognition. The key 1556 may include, for example, a physical button, an optical key, or a keypad. The ultrasonic input device 1558 may allow the electronic device 1501 to detect a sound wave using a microphone 1588, and to verify data through an input tool generating an ultrasonic signal.

The display 1560 (e.g., a display 1460 of FIG. 14) includes, for example, a panel 1562, a hologram device 1564, and a projector 1566. The panel 1562 may include the same or similar configuration to the display 1460. The panel 1562 may be implemented to be, for example, flexible, transparent, or wearable. The panel 1562 and the touch panel 1552 may be integrated into one module. The hologram device 1564 may show a stereoscopic image in a space using interference of light. The projector 1566 may project light onto a screen to display an image. The screen may be positioned, for example, inside or outside the electronic device 1501. According to an embodiment of the present disclosure, the display 1560 may further include a control circuit for controlling the panel 1562, the hologram device 1564, or the projector 1566.

The interface 1570 includes, for example, an HDMI 1572, a USB 1574, an optical interface 1576, or a D-subminiature 1578. The interface 1570 may be included in, for example, the communication interface 1470 shown in FIG. 14. Additionally or alternatively, the interface 1570 may include, for example, a mobile high definition link (MHL) interface, an SD card/MMC interface, or an infrared data association (IrDA) standard interface.

The audio module 1580 may convert a sound and an electric signal in dual directions. At least part of components of the audio module 1580 may be included in, for example, the input and output interface 1450 (or a user interface) shown in FIG. 14. The audio module 1580 may process sound information input or output through, for example, a speaker 1582, a receiver 1584, an earphone 1586, or the microphone 1588.

The camera module 1591 may capture a still image and a moving image. According to an embodiment of the present disclosure, the camera module 1591 may include one or more image sensors (e.g., a front sensor or a rear sensor), a lens, an ISP, or a flash (e.g., an LED or a xenon lamp).

The power management module 1595 may manage, for example, power of the electronic device 1501. According to an embodiment of the present disclosure, the power management module 1595 may include a power management integrated circuit (PMIC), a charger IC, or a battery gauge. The PMIC may have a wired charging method and/or a wireless charging method. The wireless charging method may include, for example, a magnetic resonance method, a magnetic induction method, or an electromagnetic method, and the like. An additional circuit for wireless charging, for example, a coil loop, a resonance circuit, or a rectifier, and the like may be further provided. The battery gauge may measure, for example, the remaining capacity of the battery 1596 and voltage, current, or temperature thereof while the battery 1596 is charged. The battery 1596 may include, for example, a rechargeable battery or a solar battery.

The indicator 1597 may display a specific state of the electronic device 1501 or part (e.g., the processor 1510) thereof, for example, a booting state, a message state, or a charging state. The motor 1598 may convert an electric signal into mechanical vibration and may generate a vibration or a haptic effect. Though not shown, the electronic device 1501 may include a processing unit (e.g., a GPU) for supporting a mobile TV. The processing unit for supporting the mobile TV may process media data according to standards, for example, a digital multimedia broadcasting (DMB) standard, a digital video broadcasting (DVB) standard, a mediaFlo standard, and the like.

Each of the above-described elements of the electronic device according to various embodiments of the present disclosure may be configured with one or more components, and names of the corresponding elements may be changed according to the type of the electronic device. The electronic device may include at least one of the above-described elements, some elements may be omitted from the electronic device, or other additional elements may be further included in the electronic device. Also, some of the elements of the electronic device may be combined with each other to form one entity, thereby making it possible to perform the functions of the corresponding elements in the same manner as before the combination.

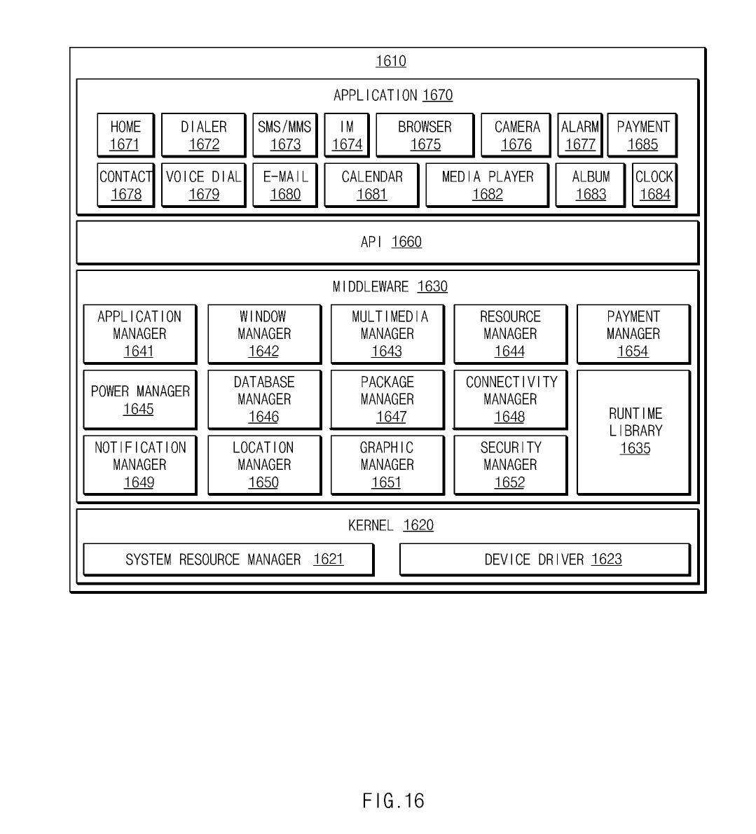

FIG. 16 is a block diagram illustrating a configuration of a program module, according to an embodiment of the present disclosure.

A program module 1610 (e.g., the program 1440 of FIG. 14) may include an OS for controlling resources associated with an electronic device (e.g., the electronic device 1401 of FIG. 14) and/or various applications (e.g., the application program 1447 of FIG. 14) which are executed on the OS.

The program module 1610 includes a kernel 1620, a middleware 1630, an API 1660, and/or an application 1670. At least part of the program module 1610 may be preloaded on the electronic device, or may be downloaded from an external electronic device (e.g., a first external electronic device 1402, a second external electronic device 1404, or a server 1406, and the like of FIG. 14).

The kernel 1620 (e.g., a kernel 1441 of FIG. 14) may include, for example, a system resource manager 1621 and/or a device driver 1623. The system resource manager 1621 may control, assign, or collect system resources. According to an embodiment of the present disclosure, the system resource manager 1621 may include a process management unit, a memory management unit, or a file system management unit. The device driver 1623 may include, for example, a display driver, a camera driver, a BT driver, a shared memory driver, a USB driver, a keypad driver, a Wi-Fi driver, an audio driver, or an inter-process communication (IPC) driver.

The middleware 1630 (e.g., the middleware 1443 of FIG. 14) may provide, for example, functions the application 1670 needs in common, and may provide various functions to the application 1670 through the API 1660, such that the application 1670 efficiently uses limited system resources in the electronic device. According to an embodiment of the present disclosure, the middleware 1630 (e.g., the middleware 1443) includes at least one of a runtime library 1635, an application manager 1641, a window manager 1642, a multimedia manager 1643, a resource manager 1644, a power manager 1645, a database manager 1646, a package manager 1647, a connectivity manager 1648, a notification manager 1649, a location manager 1650, a graphic manager 1651, a security manager 1652, and a payment manager 1654.

The runtime library 1635 may include, for example, a library module used by a compiler to add a new function through a programming language while the application 1670 is executed. The runtime library 1635 may perform a function about input and output management, memory management, or an arithmetic function.

The application manager 1641 may manage, for example, a life cycle of at least one of the application 1670. The window manager 1642 may manage graphic user interface (GUI) resources used on a screen of the electronic device. The multimedia manager 1643 may determine a format utilized for reproducing various media files and may encode or decode a media file using a codec corresponding to the corresponding format. The resource manager 1644 may manage source codes of at least one of the application 1670, and may manage resources of a memory or a storage space, and the like.

The power manager 1645 may act together with, for example, a basic input/output system (BIOS) and the like, may manage a battery or a power source, and may provide power information utilized for an operation of the electronic device. The database manager 1646 may generate, search, or change a database to be used in at least one of the application 1670. The package manager 1647 may manage installation or update of an application distributed by a type of a package file.

The connectivity manager 1648 may manage, for example, wireless connection such as Wi-Fi connection or BT connection, and the like. The notification manager 1649 may display or notify events, such as an arrival message, an appointment, and proximity notification, by a method which is not disturbed to the user. The location manager 1650 may manage location information of the electronic device. The graphic manager 1651 may manage a graphic effect to be provided to the user or a user interface (UI) related to the graphic effect. The security manager 1652 may provide all security functions utilized for system security or user authentication, and the like. According to an embodiment of the present disclosure, when the electronic device (e.g., the electronic device 1401 of FIG. 14) has a phone function, the middleware 1630 may further include a telephony manager for managing a voice or video communication function of the electronic device.

The middleware 1630 may include a middleware module that configures combinations of various functions of the above-described components. The middleware 1630 may provide a module which specializes according to kinds of OSs to provide a differentiated function. Also, the middleware 1630 may dynamically delete some of old components or may add new components.

The API 1660 (e.g., the API 1445 of FIG. 14) may be, for example, a set of API programming functions, and may be provided with different components according to OSs. For example, one or two or more API sets may be provided according to platforms.

The application 1670 (e.g., the application program 1447 of FIG. 14) includes one or more of, for example, a home application 1671, a dialer application 1672, a short message service/multimedia message service (SMS/MMS) application 1673, an instant message (IM) application 1674, a browser application 1675, a camera application 1676, an alarm application 1677, a contact application 1678, a voice dial application 1679, an e-mail application 1680, a calendar application 1681, a media player application 1682, an album application 1683, a clock application 1684, a payment application 1685, a health care application (e.g., an application for measuring quantity of exercise or blood sugar, and the like), or an environment information application (e.g., an application for providing atmospheric pressure information, humidity information, or temperature information, and the like), and the like.

According to an embodiment of the present disclosure, the application 1670 may include an information exchange application for exchanging information between the electronic device (e.g., the electronic device 1401 of FIG. 14) and an external electronic device (e.g., the first external electronic device 1402 or the second external electronic device 1404). The information exchange application may include, for example, a notification relay application for transmitting specific information to the external electronic device or a device management application for managing the external electronic device.

For example, the notification relay application may include a function of transmitting notification information, which is generated by other applications (e.g., the SMS/MMS application, the e-mail application, the health care application, or the environment information application, and the like) of the electronic device, to the external electronic device (e.g., the first external electronic device 1402 or the second external electronic device 1404). Also, the notification relay application may receive, for example, notification information from the external electronic device, and may provide the received notification information to the user of the electronic device.

The device management application may manage (e.g., install, delete, or update), for example, at least one (e.g., a function of turning on/off the external electronic device itself (or partial components) or a function of adjusting brightness (or resolution) of a display) of the functions of the external electronic device (e.g., the first external electronic device 1402 or the second external electronic device 1404), which communicates with the electronic device, an application that operates in the external electronic device, or a service (e.g., a call service or a message service) provided from the external electronic device.

According to an embodiment of the present disclosure, the application 1670 may include an application (e.g., the health card application of a mobile medical device) that is preset according to attributes of the external electronic device (e.g., the first external electronic device 1402 or the second external electronic device 1404). The application 1670 may include an application received from the external electronic device (e.g., the server 1406, the first external electronic device 1402, or the second external electronic device 1404). The application 1670 may include a preloaded application or a third party application which may be downloaded from a server. Names of the components of the program module 1610 may differ according to kinds of OSs.

According to various embodiments of the present disclosure, at least part of the program module 1610 may be implemented with software, firmware, hardware, or at least two or more combinations thereof. At least part of the program module 1610 may be implemented (e.g., executed) by, for example, a processor (e.g., the processor 1510 of FIG. 15). At least part of the program module 1610 may include, for example, a module, a program, a routine, sets of instructions, or a process, and the like for performing one or more functions.

The term “module”, as used herein, may represent, for example, a unit including one of hardware, software, and firmware, or a combination thereof. The term “module” may be interchangeably used with the terms “unit”, “logic”, “logical block”, “component”, and “circuit”. A module may be a minimum unit of an integrated component or may be a part thereof. A module may be a minimum unit for performing one or more functions or a part thereof. A module may be implemented mechanically or electronically. For example, a module may include at least one of an application-specific integrated circuit (ASIC) chip, a field-programmable gate array (FPGA), and a programmable-logic device for performing some operations, which are known or will be developed.

At least a part of devices (e.g., modules or functions thereof) or methods (e.g., operations), according to various embodiments of the present disclosure, may be implemented as instructions stored in a computer-readable storage medium in the form of a program module. In the case where the instructions are performed by a processor (e.g., the processor 1420), the processor may perform functions corresponding to the instructions. The computer-readable storage medium may be, for example, the memory 1430.

A computer-readable recording medium may include a hard disk, a floppy disk, a magnetic medium (e.g., a magnetic tape), an optical medium (e.g., CD-ROM, DVD), a magneto-optical medium (e.g., a floptical disk), or a hardware device (e.g., a ROM, a RAM, a flash memory, or the like). The program instructions may include machine language codes generated by compilers and high-level language codes that can be executed by computers using interpreters. The above-described hardware device may be configured to be operated as one or more software modules for performing operations of various embodiments of the present disclosure and vice versa.

For example, an electronic device may include a processor and a memory for storing computer-readable instructions. The memory may include instructions for performing the above-described methods or functions when executed by the processor. For example, the memory may include instructions that, when executed by the processor, cause the processor to execute obtaining an image of an object using a first exposure configuration, detecting a shape from the image based on luminance information of the image, and changing the first exposure configuration to a second exposure configuration, if the shape is detected.

A module or a program module according to various embodiments of the present disclosure may include at least one of the above-mentioned elements, or some elements may be omitted or other additional elements may be added. Operations performed by the module, the program module or other elements according to various embodiments of the present disclosure may be performed in a sequential, parallel, iterative or heuristic way. Furthermore, some operations may be performed in another order or may be omitted, or other operations may be added.

While the present disclosure has been shown and described with reference to certain embodiments thereof, it will be understood by those skilled in the art that various changes in form and detail may be made therein without departing from the spirit and scope of the present disclosure.

What is claimed is:

1. An electronic device, comprising:
a photographing module configured to obtain an image of an object using a first exposure configuration; and
a processor configured to determine whether a designated shape is in the image based on luminance information of the image, and, change the first exposure configuration to a second exposure configuration when the designated shape is in the image.

2. The electronic device of claim 1, wherein the first and second exposure configurations each comprise at least one of an aperture value, a shutter speed, and a sensitivity of an image sensor of the electronic device.

3. The electronic device of claim 1, wherein the processor is further configured to:
determine whether the image is photographed in a backlight condition based on the luminance information of the image,
determine whether the designated shape is in the image when the image is photographed in the backlight condition.

4. The electronic device of claim 1, wherein the processor is further configured to determine whether the designated shape is in the image when face detection on the image fails.

5. The electronic device of claim 1, wherein the processor is further configured to determine whether the designated shape is in the image based on a result of comparing a first luminance value of a first region included in the image with a second luminance value of a second region adjacent to the first region.

6. The electronic device of claim 1, wherein the processor is further configured to:
extract at least one feature point from the image; and
determining whether the designated shape is in the image based on a comparison of a pattern of the at least one feature point with a pattern corresponding to the designated shape.

7. The electronic device of claim 1, wherein the processor is further configured to store image data corresponding to a region where the designated shape is detected in the image in a memory operatively connected with the electronic device.

8. The electronic device of claim 7, wherein the processor is further configured to perform face detection in the region where the designated shape is detected, based on the image data stored in the memory.

9. The electronic device of claim 1, wherein the processor is further configured to perform face detection on a second image obtained using the second exposure configuration.

10. The electronic device of claim 1, wherein the designated shape is an omega shape.

11. An electronic device for obtaining an image for an object, the electronic device comprising:
a memory configured to store the image;
a display configured to output a preview image for the image; and
a processor configured to store the image in the memory if user input for an image photographing command is received, and to determine whether a designated shape is in the image based on luminance information of the image,
wherein the processor is further configured to change an exposure configuration of a photographing module of the electronic device when the designated shape is in the image.

12. A face detection method of an electronic device, the method comprising:
obtaining an image of an object using a first exposure configuration;
determining whether a designated shape is in the image based on luminance information of the image; and
changing the first exposure configuration to a second exposure configuration, when the designated shape is detected.

13. The method of claim 12, wherein changing to the second exposure configuration comprises at least one of:
changing an aperture value of an aperture included in the electronic device;
changing a shutter speed of a shutter included in the electronic device; and
changing a sensitivity of an image sensor included in the electronic device.

14. The method of claim 12, wherein determining whether the designated shape is in the image comprises:
determining whether the image is photographed in a backlight condition based on the luminance information of the image; and
determining whether the designated shape is in the image, when the image is photographed in the backlight condition.

15. The method of claim 12, wherein determining whether the designated shape is in the image comprises:
determining whether the designated shape is in the image when face detection in the image fails.

16. The method of claim 12, wherein determining whether the designated shape is in the image comprises:
determining whether the designated shape is in the image based on a result of comparing a first luminance value of a first region included in the image with a second luminance value of a second region adjacent to the first region.

17. The method of claim 12, wherein determining whether the designated shape is in the image comprises:
extracting at least one feature point from the image; and
determining whether the designated shape is in the image based on a comparison of a pattern of the at least one feature point with a pattern corresponding to the designated shape.

18. The method of claim 12, further comprising:
storing image data corresponding to a region where the designated shape is detected in the image in a memory operatively connected with the electronic device.

19. The method of claim 18, further comprising:
performing face detection from the region where the designated shape is detected, based on the image data stored in the memory.

20. The method of claim 12, further comprising:
performing face detection in a second image obtained using the second exposure configuration.
